(19) United States
(12) Patent Application Publication
(10) Pub. No.: US 2025/0343015 A1
(43) Pub. Date: Nov. 6, 2025

(54) ISOLATING SWITCH BODY, ISOLATING SWITCH, AND POWER DISTRIBUTION SYSTEM

(71) Applicant: SHANGHAI LIANGXIN ELECTRICAL CO., LTD., Shanghai (CN)

(72) Inventors: Sheng'ai Li, Shanghai (CN); Yipeng Yu, Shanghai (CN); Weijian Peng, Shanghai (CN); Li Ba, Shanghai (CN); Mingxue Zhang, Shanghai (CN); Jiajun Lu, Shanghai (CN); Lingling Wei, Shanghai (CN); Xinmei Liu, Shanghai (CN)

(21) Appl. No.: 19/273,377

(22) Filed: Jul. 18, 2025

Related U.S. Application Data
(63) Continuation-in-part of application No. PCT/CN2024/073099, filed on Jan. 18, 2024.

(30) Foreign Application Priority Data
Jan. 19, 2023 (CN) 202310091148.X
Jan. 19, 2023 (CN) 202320170447.8
Dec. 27, 2023 (CN) 202323607189.4
Dec. 27, 2023 (CN) 202323607219.1

(51) Int. Cl. H01H 19/14; H01H 19/64

(52) U.S. Cl. CPC H01H 19/14; H01H 19/64

(57) ABSTRACT

An isolating switch body, an isolating switch, and a power distribution system are provided. The isolating switch body includes body modules, where each body module includes a plurality of layers of switch units which are stacked, the plurality of layers of switch units are connected through respective body rotating shafts, and a plurality of groups of body modules are spliced to form the isolating switch body; the body rotating shafts of the switch units are linked with an operating mechanism through a transmission mechanism in a first direction perpendicular to a stacking direction. The handle shaft is rotated to drive the operating mechanism to act, and then the body modules are driven through the transmission mechanism to achieve synchronous opening and closing.

### CROSS-REFERENCE TO RELATED APPLICATION

The present application is a continuation-in-part application based on International Patent Application No. PCT/CN2024/073099, which claims priorities to application No. 202310091148.X filed on Jan. 19, 2023 to China National Intellectual Property Administration and entitled “ISOLATING SWITCH”, application No. 202320170447.8 filed on Jan. 19, 2023 to China National Intellectual Property Administration and entitled “POWER DISTRIBUTION SYSTEM”, application No. 202323607219.1 filed on Dec. 27, 2023 to China National Intellectual Property Administration and entitled “ISOLATING SWITCH AND POWER DISTRIBUTION SYSTEM”, and application No. 202323607189.4 filed on Dec. 27, 2023 to China National Intellectual Property Administration and entitled “ISOLATING SWITCH BODY AND ISOLATING SWITCH”.

### TECHNICAL FIELD

The present disclosure relates to the technical field of low-voltage electric appliances, in particular to an isolating switch body, an isolating switch, and a power distribution system.

### BACKGROUND

An isolating switch is a switch device mainly used for “isolating a power supply, performing switching operation, and connecting and disconnecting a small current circuit”. Generally, the isolating switch includes an operating mechanism and a body, while the body can be formed by stacking a plurality of layers of switch units, and theoretically, the plurality of layers of switch units can be driven by the operating mechanism to perform synchronous action so as to achieve synchronous opening and closing.

However, in practical operation, in the structure in which the plurality of layers of switch units are stacked, the larger the quantity of the stacked switch units is, the larger the transmission error between the first layer of switch unit and the last layer of switch unit is, so that the synchronization of the plurality of layers of switch units is affected.

### SUMMARY

The present disclosure aims to provide an isolating switch body, an isolating switch, and a power distribution system, aiming at the defects in the prior art.

In order to achieve the above objective, embodiments of the present disclosure adopt the following technical solutions:

In one aspect of the embodiments of the present disclosure, an isolating switch body is provided. The isolating switch body includes body modules, each body module includes a plurality of layers of switch units which are stacked, the plurality of layers of switch units are connected through respective body rotating shafts, and a plurality of groups of body modules are spliced to form the isolating switch body; the body rotating shafts of the switch units are linked with an operating mechanism through a transmission mechanism in a first direction perpendicular to a stacking direction.

Optionally, the transmission mechanism has one or more rotation shafts, the rotation shafts are connected to the body modules, the transmission mechanism can drive the body modules to rotate synchronously, and the transmission mechanism is disposed in a middle or on one side or both sides of the body modules.

Optionally, when the body modules are opened or closed, rotation directions of the body rotating shafts are the same or symmetrical.

Optionally, two symmetrical stationary contacts are disposed in each switch unit along the corresponding body rotating shaft, arc spraying ports are further respectively formed on each switch unit and on both sides of a stationary contact plate of each stationary contact in the first direction, and the arc spraying ports are used for communicating with an arc extinguishing chamber.

Optionally, two symmetrical stationary contacts are disposed in each switch unit along the corresponding body rotating shaft, and when each body module includes three layers of switch units, a connection line of fastening points of stationary contact plates of the stationary contacts of the three layers of switch units is triangular; in the plurality of layers of switch units of the body module, mounting surfaces of wiring terminals and the stationary contacts are parallel to each other.

Optionally, two symmetrical stationary contacts are disposed in each switch unit along the corresponding body rotating shaft, and the stationary contacts of the switch unit extend toward the body rotating shaft; the stationary contacts of the switch units are led out along a middle of a housing, and the stationary contacts can be respectively bent toward both sides or the middle of the housing to form a contact surface for external wiring.

In another aspect of the embodiments of the present disclosure, an isolating switch is provided. The isolating switch includes a handle shaft, an operating mechanism, and at least one stage of any one of the isolating switch bodies described above, which are linked in sequence.

Optionally, when a plurality of stages of isolating switch bodies are provided, the plurality of stages of isolating switch bodies are cascaded along a first direction, and a quantity of the cascaded stages does not exceed three.

Optionally, when a plurality of stages of isolating switch bodies are provided, two adjacent stages of isolating switch bodies are clamped through switch units outermost in a stacking direction or fixedly connected along the first direction through screws.

Optionally, when the two adjacent stages of isolating switch bodies are clamped, housings of adjacent stages of switch units outermost in the stacking direction are separately provided with adaptive grooves and protrusions.

In another aspect of the embodiments of the present disclosure, an isolating switch is provided. The isolating switch includes an operating mechanism and a switch body, the operating mechanism is in driving connection to the switch body to drive the switch body to be opened or closed, and extension directions of a rotation shaft of the operating mechanism and a rotation shaft of the switch body do not overlap.

Optionally, the extension directions of the rotation shaft of the operating mechanism and the rotation shaft of the switch body are parallel or perpendicular.

Optionally, the switch body includes at least one switch assembly, the switch assembly has a rotation shaft extending along a first direction and in driving connection to the operating mechanism, and the switch assembly includes at least one switch unit stacked along the first direction.

Optionally, the switch assemblies are stacked along a second direction perpendicular to the first direction.

Optionally, the operating mechanism and the switch body are stacked along the second direction perpendicular to the first direction.

Optionally, the isolating switch further includes a transmission member extending along the second direction, and the operating mechanism is in driving connection to the rotation shaft of the switch assembly through the transmission member.

Optionally, a plurality of switch units of the same switch assembly are all distributed on the same side of the transmission member.

Optionally, a plurality of switch units of the same switch assembly are distributed on opposite sides of the transmission member.

Optionally, the plurality of switch units of the same switch assembly are symmetrically distributed on opposite sides of the transmission member.

Optionally, the transmission member includes a translational portion and a rotary portion which are connected to each other, the translational portion extends along the second direction, and the operating mechanism is in driving connection to the rotation shaft of the switch assembly sequentially through the translational portion and the rotary portion.

Optionally, the translational portion is a connecting bar, and the rotary portion is hinged to the connecting bar.

Optionally, a kidney-shaped hole is formed at an end portion of the connecting bar, and a driving end of the operating mechanism is slidably connected to the kidney-shaped hole.

Optionally, the translational portion is a rack, and the rotary portion is a gear meshing with the rack.

Optionally, the isolating switch further includes a handle, the handle is in driving connection to the switch body through the operating mechanism, and the handle, the operating mechanism, and the switch body are arranged along the second direction; or, the isolating switch further includes a handle, the handle is in driving connection to the switch body through the operating mechanism, and the handle and the operating mechanism are arranged along a direction perpendicular to the second direction.

Optionally, a release is further disposed on one side of the operating mechanism, the release has a driving portion, the operating mechanism has a driven portion in driving cooperation with the driving portion, and a gap is formed between the driving portion and the driven portion.

Optionally, a release is further disposed on one side of the operating mechanism, the release has a driving portion, the operating mechanism has a driven portion in driving cooperation with the driving portion, and a gap is formed between the driving portion and the driven portion. Optionally, the operating mechanism is a four-bar linkage mechanism.

In yet another aspect of the embodiments of the present disclosure, an isolating switch is provided. The isolating switch includes an operating mechanism and a switch body, the switch body includes at least one layer of switch assembly stacked along a first direction, the switch assembly includes a plurality of switch units arranged on the same layer, at least two switch units located on the same layer are connected in series inside the switch assembly, and the operating mechanism is in driving connection to the switch units in the switch body to drive the switch body to be opened or closed.

Optionally, at least two switch units located on the same layer are connected in series inside the switch assembly to form a series connection group, the plurality of switch units located on the same layer form a plurality of series connection groups, and the plurality of series connection groups are connected in parallel and/or in series.

Optionally, at least two adjacent switch units in the plurality of switch units located on the same layer are connected in series.

Optionally, each switch unit includes a unit housing, and a movable contact and a stationary contact that are located in the unit housing, and the operating mechanism is in driving connection to the movable contact, so that the movable contact and the stationary contact cooperate to be closed or opened; the unit housings of two switch units connected in series are adjoined, and respective stationary contacts of the two switch units connected in series are short-circuited at an adjoined position of the unit housings.

Optionally, each switch unit has a rotation shaft in driving connection to the operating mechanism, and the rotation shafts of the plurality of switch units located on the same layer are parallel to each other.

Optionally, the switch body includes a plurality of layers of switch assemblies, the switch units in two adjacent layers of switch assemblies are stacked in one-to-one correspondence along the first direction, and the rotation shafts of the switch units stacked correspondingly along the first direction in the plurality of layers of switch assemblies are coaxially disposed.

Optionally, an axis of a rotation shaft of the operating mechanism does not overlap with an axis of the rotation shaft of each switch unit, and the axis of the rotation shaft of the operating mechanism is parallel or perpendicular to the axis of the rotation shaft of each switch unit.

Optionally, the isolating switch further includes a transmission assembly, and the operating mechanism is in driving connection to the rotation shafts of the switch units through the transmission assembly; the transmission assembly includes a transmission rod and a plurality of transfer members rotatably connected to the transmission rod, the plurality of transfer members are in one-to-one corresponding driving connection to the rotation shafts of the switch units located on the same layer, and the operating mechanism is in driving connection to the rotation shafts of the switch units sequentially through the transmission rod and the transfer members; or, the transmission assembly includes a first transmission gear and a plurality of second transmission gears meshing with the first transmission gear, the plurality of second transmission gears are in one-to-one corresponding driving connection to the rotation shafts of the switch units located on the same layer, and the operating mechanism is in driving connection to the rotation shafts of the switch units sequentially through the first transmission gear and the second transmission gears.

Optionally, the operating mechanism and the switch body are stacked along the first direction or along a second direction perpendicular to the first direction.

Optionally, a plug-in terminal for being plugged with a circuit board is provided on one side of the switch body.

In yet another aspect of the embodiments of the present disclosure, a power distribution system is provided. The power distribution system includes a direct current input module, an output module, and any one of the above isolating switches, and the isolating switch is electrically connected between the direct current input module and the output module.

In yet another aspect of the embodiments of the present disclosure, a power distribution system is provided. The power distribution system includes a switch, a direct current input module, and an output module, the switch is electrically connected between the direct current input module and the output module, the switch can be controlled to be switched from a closed state to an open state, the switch includes a breaking body and an action mechanism, the breaking body rotates around a first direction, the action mechanism rotates around a second direction, and the first direction does not overlap with the second direction.

Optionally, the first direction and the second direction are perpendicular or parallel to each other.

Optionally, the breaking body is constituted by a plurality of body assemblies, each body assembly has a rotation central shaft, and single bodies are stacked in each body assembly along the first direction in which the rotation central shaft extends.

Optionally, the body assemblies are disposed along a direction perpendicular to the first direction.

Optionally, the switch further includes an operating handle, and the breaking body, the action mechanism, and the operating handle are stacked sequentially along the direction perpendicular to the first direction.

Optionally, the power distribution system further includes a control module, and the control module is configured to transmit a fault signal to the switch when the direct current input module or the output module fails, so that the switch is switched from the closed state to the open state after receiving the fault signal.

Optionally, the control module has a capacitor module, the power distribution system charges the capacitor module, and when the power distribution system fails, the capacitor module discharges and releases energy to transmit the fault signal to the switch, so that the switch is driven to complete transition of a contact from the closed state to the open state.

Optionally, the output module is partially fixedly connected to the switch, and the output module is soldered to a stationary contact of the switch.

Optionally, the direct current input module is connected to the switch, the direct current input module is connected to a stationary contact of the switch through a wire, and the connection is screw fastening.

Optionally, the power distribution system further includes a box body, and an operating handle of the switch is disposed on an outer side of the box body.

The beneficial effects of the present disclosure include:

According to the isolating switch body, the isolating switch, and the power distribution system provided in the present disclosure, the isolating switch body includes the body modules, each body module includes the plurality of layers of switch units which are stacked, the plurality of layers of switch units are connected through respective body rotating shafts, and the plurality of groups of body modules are spliced to form the isolating switch body; the body rotating shafts of the switch units are linked with the operating mechanism through the transmission mechanism in the first direction perpendicular to the stacking direction. The handle shaft is rotated to drive the operating mechanism to act, and then the body modules are driven through the transmission mechanism to achieve synchronous opening and closing. When the isolating switch body is applied to the isolating switch, the above body modules can be disposed in the first direction and the stacking direction separately, the two-way layout method can effectively reduce the length of the isolating switch in the first direction, and then the synchronization among the plurality of layers of switch units is ensured.

### BRIEF DESCRIPTION OF THE DRAWINGS

In order to more clearly illustrate the technical solutions in embodiments of the present disclosure, the drawings required for use in the embodiments will be briefly described below. It should be understood that the following drawings only illustrate some embodiments of the present disclosure and therefore should not be considered as limiting the scope of the present disclosure, and other related drawings can be derived from these drawings by those of ordinary skill in the art without creative efforts.

FIG. 1 is a first schematic structural diagram of a body module according to an embodiment of the present disclosure;

FIG. 2 is a schematic structural diagram of an isolating switch according to an embodiment of the present disclosure;

FIG. 3 is a first schematic diagram of a partial structure of an isolating switch according to an embodiment of the present disclosure;

FIG. 4 is a second schematic diagram of a partial structure of an isolating switch according to an embodiment of the present disclosure;

FIG. 5 is a third schematic diagram of a partial structure of an isolating switch according to an embodiment of the present disclosure;

FIG. 6 is a schematic structural diagram of a switch unit according to an embodiment of the present disclosure;

FIG. 7 is a second schematic structural diagram of a body module according to an embodiment of the present disclosure;

FIG. 8 is a first schematic structural diagram of an isolating switch according to an embodiment of the present disclosure;

FIG. 9 is a second schematic structural diagram of an isolating switch according to an embodiment of the present disclosure;

FIG. 10 is a third schematic structural diagram of an isolating switch according to an embodiment of the present disclosure;

FIG. 11 is a first schematic structural diagram of a switch body according to an embodiment of the present disclosure;

FIG. 12 is a second schematic structural diagram of a switch body according to an embodiment of the present disclosure;

FIG. 13 is a cross-sectional diagram of an isolating switch according to an embodiment of the present disclosure;

FIG. 14 is a schematic structural diagram of connection between an operating mechanism, a transmission member, and movable contacts according to an embodiment of the present disclosure;

FIG. 15 is a schematic structural diagram of cooperation of an operating mechanism and a release according to an embodiment of the present disclosure;

FIG. 16 is a fourth schematic structural diagram of an isolating switch according to an embodiment of the present disclosure;

FIG. 17 is a fifth schematic structural diagram of an isolating switch according to an embodiment of the present disclosure;

FIG. 18 is a sixth schematic structural diagram of an isolating switch according to an embodiment of the present disclosure;

FIG. 19 is a first schematic structural diagram of an isolating switch according to an embodiment of the present disclosure;

FIG. 20 is a first schematic structural diagram of a switch assembly according to an embodiment of the present disclosure;

FIG. 21 is a second schematic structural diagram of a switch assembly according to an embodiment of the present disclosure;

FIG. 22 is a second schematic structural diagram of an isolating switch according to an embodiment of the present disclosure;

FIG. 23 is a schematic structural diagram of a transmission assembly according to an embodiment of the present disclosure;

FIG. 24 is a schematic diagram of an onboard structure of an isolating switch according to an embodiment of the present disclosure;

FIG. 25 is a schematic structural diagram of a power distribution system according to an embodiment of the present disclosure;

FIG. 26 is a schematic structural diagram of a power distribution system according to an embodiment of the present disclosure;

FIG. 27 is a schematic structural diagram of a switch according to an embodiment of the present disclosure; and

FIG. 28 is an assembly schematic diagram of a box body and a power distribution system according to an embodiment of the present disclosure.

Reference numerals: 10, 100, 010—operating mechanism; 11—handle shaft; 601—transmission mechanism; 101—first connecting bar; 102—second connecting bar; 103—third connecting bar; 104—fifth connecting bar; 105—sixth connecting bar; 106—seventh connecting bar; 20—isolating switch body; 21—body module; 201, 220, 0210—switch unit; 202—body rotating shaft; 202a—connecting groove; 202b—mounting hole; 203, 203a, 203b, 203c—screw; 204—groove; 205—protrusion; 206, 225, 0212—stationary contact; 206a—stationary contact plate; 207—arc spraying port; F1—first direction; F2—stacking direction; 110—housing; 120—driven portion; 130—driving end; 200, 020—switch body; 210, 0200—switch assembly; 221, 0211—unit housing; 222, 0213—movable contact; 223—movable contact support; 224—rotating shaft; 226—arc extinguishing chamber; 310, 030—handle; 320—signal terminal; 330—transmission member; 331—connecting bar; 332—kidney-shaped hole; 333—rotary portion; 340—release; 341—driving portion; 040—circuit board; 050, 602—direct current input module; 060—isolating switch; 070, 300—output module; 080, 400—control module; 090, 01—power distribution system; 0100—operating housing; 0121—first transmission gear; 0122—second transmission gear; 0131—transmission rod; 0132—transfer member; 0214—rotation shaft of switch unit; 0215—adjoined position of unit housings; 0216—wiring terminal; 0217—plug-in terminal; 0220—arc extinguishing apparatus; 604—switch; 605—operating handle; 603—action mechanism; 230—breaking body; 231—body assembly; 2311—body; 2312—contact assembly; 2313—rotation central shaft; and 500—box body.

### DETAILED DESCRIPTION

To make the objectives, technical solutions, and advantages of embodiments of the present disclosure clearer, the technical solutions in the embodiments of the present disclosure will be clearly and completely described below with reference to the drawings in the embodiments of the present disclosure. It is evident that the described embodiments are some, but not all embodiments of the present disclosure. Components of the embodiments of the present disclosure generally described and illustrated in the drawing herein may be arranged and designed in various configurations.

Therefore, the following detailed description of the embodiments of the present disclosure provided in the drawings is not intended to limit the scope of the present disclosure as claimed, but merely represents selected embodiments of the present disclosure. It should be noted that, unless conflicting, various features of the embodiments of the present disclosure may be combined with each other, and the combined embodiments still fall within the protection scope of the present disclosure.

In the description of the present disclosure, it should be noted that the terms “middle”, “upper”, “lower”, “left”, “right”, and the like indicate orientations or positional relationships based on orientations or positional relationships shown in the drawings, or orientations or positional relationships commonly assumed when using the product of the present disclosure, and thus should not be construed as limiting the present disclosure. Furthermore, the terms “first”, “second”, “third”, and the like are used for distinguishing descriptions only and shall not be construed as indicating or implying relative importance.

In the description of the present disclosure, it should also be noted that, unless otherwise explicitly specified or limited, the terms “disposed” and “communicated” shall be interpreted broadly and may be, for example, direct connection, indirect connection via an intermediate, or internal communication between two elements. For those of ordinary skill in the art, the specific meaning of the above terms in the present disclosure may be understood according to the specific condition.

In the layout of an existing unidirectional stacked switch body, the greater the quantity of stacked layers of switch units, the greater the transmission error between the head layer and the tail layer.

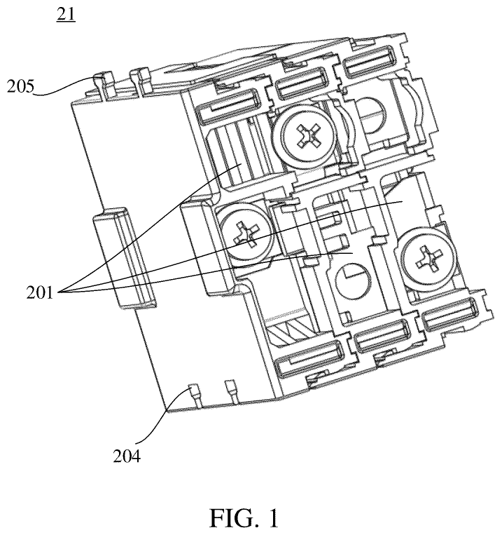

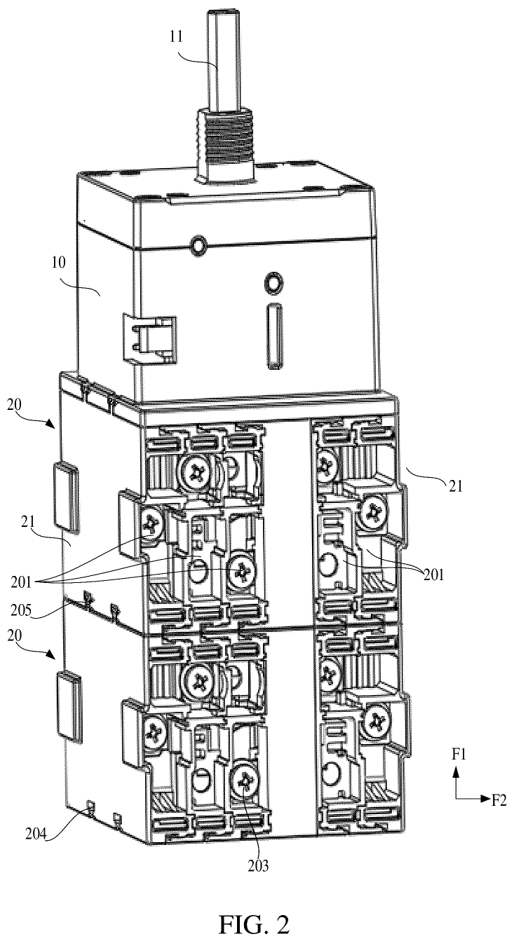

In order to solve the above problems, the embodiments of the present disclosure provide an isolating switch body 20 and an isolating switch. By the arrangement of modularized body modules 21, the body modules 21 can be disposed in two directions as required, so as to improve the synchronization among a plurality of layers of switch units 201. Specifically, referring to FIG. 1 and FIG. 2, one aspect of the embodiments of the present disclosure provides an isolating switch body 20, which includes body modules 21. Each body module 21 includes a plurality of layers of switch units 201 which are stacked, the plurality of layers of switch units 201 are connected through respective body rotating shafts 202, and a plurality of groups of body modules 21 are spliced to form the isolating switch body 20; the body rotating shafts 202 of the switch units 201 are linked with an operating mechanism 10 through a transmission mechanism 601 in a first direction F1 perpendicular to a stacking direction F2.

Generally, the quantity of stacked layers of the switch units 201 in each body module 21 may be two or three, and since the quantity of layers of mainstream switches in the market is mostly an even number such as 4, 6, 8, 10, 12, etc., the least common divisor 2 or 3 is taken to meet the requirements of all the layers. Therefore, in one embodiment of the present disclosure, the quantity of stacked layers of the switch units 201 is set to be two or three. The body modules 21, which are arranged in a modularized manner, each include two layers or three layers of switch units 201, the two layers or three layers of switch units 201 are stacked in the stacking direction F2, each layer of switch unit 201 is provided with a body rotating shaft 202, and the stacked switch units 201 are synchronously linked through the respective body rotating shafts 202.

In one embodiment, connecting grooves 202a or bosses are provided at two symmetrical ends of one body rotating shaft 202; the body rotating shafts 202 of two adjacent layers of switch units 201 are connected through the cooperation of adjacent connecting grooves 202a and bosses.

One body module 21 is connected to the transmission mechanism 601 in the first direction F1 through the body rotating shafts 202 of the switch units 201. Exemplarily, the transmission mechanism 601 is a four-bar linkage mechanism, and the operating mechanism 10 and the body modules 21 are in transmission connection through the four-bar linkage mechanism.

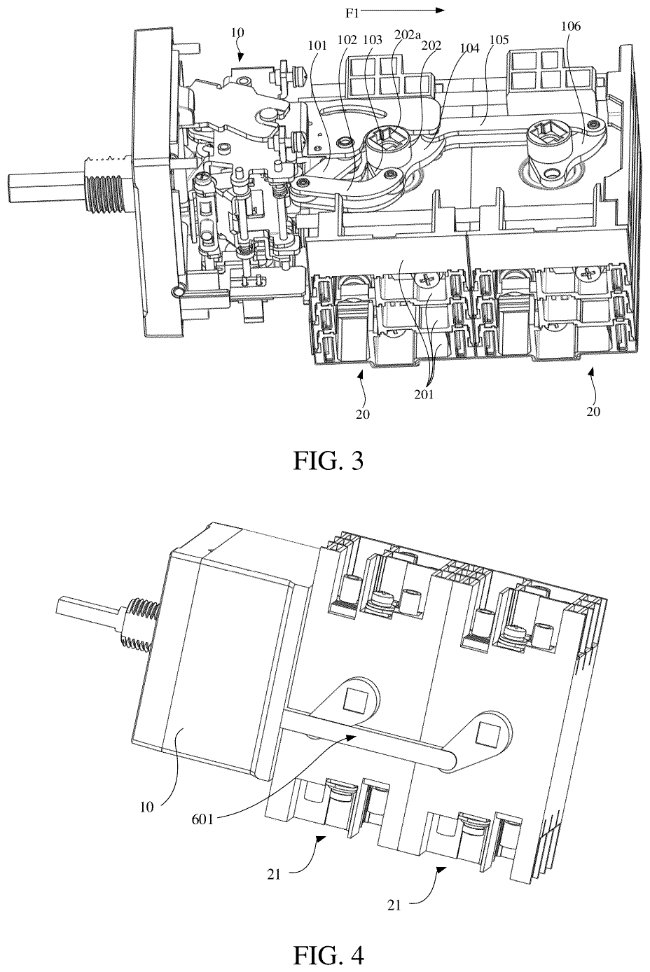

As shown in FIG. 3, the four-bar linkage mechanism includes a first connecting bar 101, a second connecting bar 102, a third connecting bar 103, and a virtual fourth connecting bar formed between the body rotating shaft 202 and the end portion of the first connecting bar, all of which are connected in sequence. The output end of the operating mechanism 10 is connected to the end portion of the first connecting bar, and the operating mechanism 10 drives the body rotating shafts 202 to rotate through the four-bar linkage mechanism. Thus, the operating mechanism 10, the transmission mechanism 601, and the body rotating shafts 202 are driven to operate by operating a handle shaft 11, and the layers of switch units 201 are synchronously linked through the body rotating shafts 202.

In the stacking direction F2, the quantity of the body modules 21 can be selected as required to meet different requirements. In an implementation, there are two body modules 21, the two body modules 21 are symmetrically disposed on both sides of the transmission mechanism 601 along the stacking direction F2, and the body modules 21 on the both sides are connected through respective body rotating shafts 202.

Further, the transmission mechanism 601 has one or more rotation shafts, the rotation shaft is connected to the body modules 21, the transmission mechanism 601 can drive the body modules 21 to rotate synchronously, and the transmission mechanism 601 is disposed in the middle or on one side or both sides of the body modules 21.

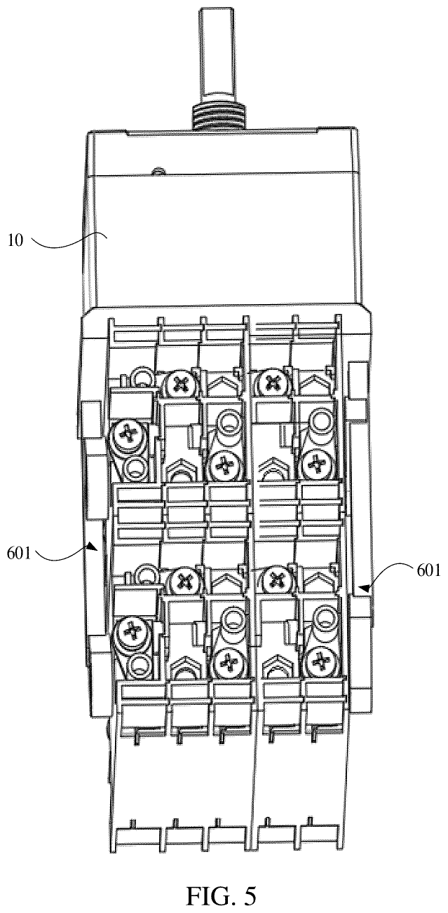

In FIG. 2 and FIG. 3, the transmission mechanism 601 is disposed in the middle of the body modules 21, and the body modules 21 are disposed on both sides of the transmission mechanism 601. In FIG. 4, the transmission mechanism 601 is disposed on one side of the body modules 21. In FIG. 5, the transmission mechanisms 601 are disposed on both sides of the body modules 21.

Exemplarily, as shown in FIG. 2, in the body modules 21 on both sides, the body module 21 on one side has two layers of switch units 201, and the body module 21 on the other side has three layers of switch units 201; or, the body modules 21 on both sides both have two layers of switch units 201; it is also possible that the body modules 21 on both sides both have three layers of switch units 201.

In addition, the rotation directions of the body rotating shafts 202 are the same or symmetrical during the opening and closing operation. When the transmission mechanism 601 is disposed in the middle of the body module 21, as shown in FIG. 2 and FIG. 3, the rotation directions of the body modules 21 on both sides of the transmission mechanism 601 are symmetrical. When the transmission mechanism 601 is disposed on one side of the body modules 21 as shown in FIG. 4, or when the transmission mechanisms 601 are disposed on both sides of the body modules 21 as shown in FIG. 5, the rotation directions of the body modules 21 are the same.

Therefore, the isolating switch body 20 provided by the embodiments of the present disclosure includes the modularized body modules 21, each body module 21 includes two layers or three layers of switch units 201, and the two layers or three layers of switch units 201 are disposed in the stacking direction F2 and are connected through the respective body rotating shafts 202; the body rotating shaft 202 of one layer of switch unit 201 is linked with the operating mechanism 10 through the transmission mechanism 601 in the first direction F1, and the first direction F1 is perpendicular to the stacking direction F2; the handle shaft 11 is rotated to drive the operating mechanism 10 to act, and then the body modules 21 are driven through the transmission mechanism 601 to achieve synchronous opening and closing. When the isolating switch body is applied to the isolating switch, the above body modules 21 can be disposed in the first direction F1 and the stacking direction F2 separately, the two-way layout method can effectively reduce the length of the isolating switch in the first direction F1, and then the synchronization among the plurality of layers of switch units 201 is ensured.

Further, two symmetrical stationary contacts 206 are disposed in each switch unit 201 along the corresponding body rotating shaft 202, arc spraying ports 207 are further separately formed on each switch unit 201 and on both sides of a stationary contact plate 206a of each stationary contact 206 in the first direction F1, and the arc spraying ports 207 are used for communicating with an arc extinguishing chamber.

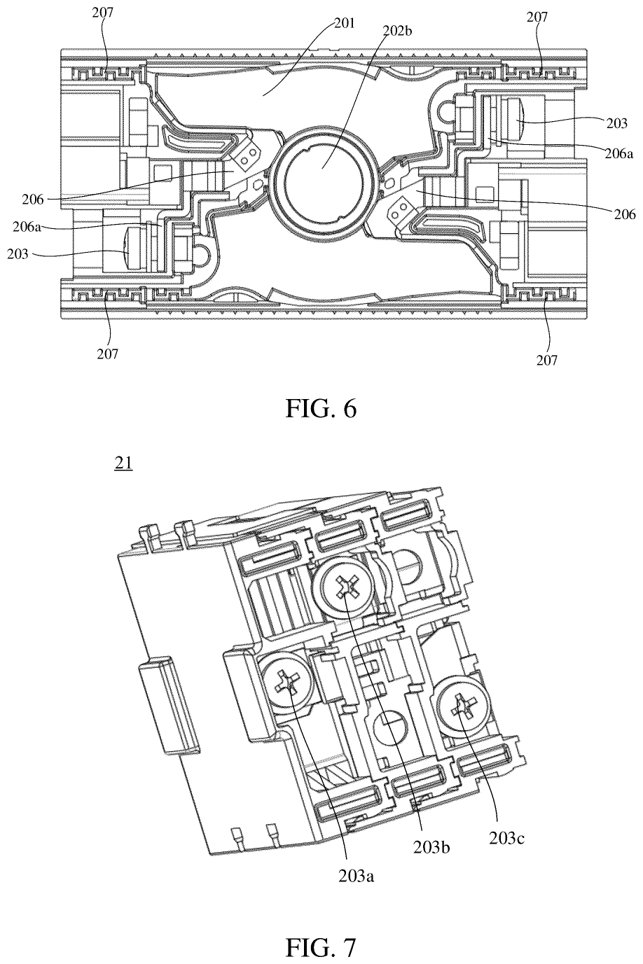

As shown in FIG. 3, two stationary contacts 206 are disposed in the switch unit 201, and the two stationary contacts 206 are symmetrically disposed along the body rotating shaft 202 (a mounting hole 202b of the body rotating shaft 202 in FIG. 6); a housing of the switch unit 201 is further provided with four arc spraying ports 207, where two of the arc spraying ports 207 form a group and are located on both sides of the stationary contact plate 206a of one stationary contact 206 along the first direction F1.

The arc spraying ports 207 are connected to the arc extinguishing chamber, and the arc extinguishing chamber communicates with the outside through the arc spraying ports 207. One switch unit 201 is provided with four arc spraying ports 207, so that the arc extinguishing effect is improved.

In the plurality of layers of switch units 201 of the body module 21, projections of the stationary contacts 206 of adjacent switch units 201 overlap, and the stationary contact plates 206a of the adjacent switch units 201 are disposed in a staggered manner.

In one embodiment, when the body module 21 includes three layers of switch units 201, the connection line of fastening points of the stationary contact plates 206a of the three layers of switch units 201 is triangular.

As shown in FIG. 1, the stationary contact plates 206a at the tail ends of the stationary contacts 206 are fixed to the housings of the switch units 201 through screws 203, and in the body module 21 formed by the three layers of switch units 201, the connection line of fastening points of the stationary contact plates 206a of the three layers of switch units 201 and the screws 203 form a triangle, so as to stabilize the overall structure of the body module 21.

Further, the stationary contacts 206 of the switch unit 201 extend toward the body rotating shaft 202; the stationary contacts 206 are led out along the middle of the housing, and the stationary contacts 206 can be respectively bent toward both sides or the middle of the housing to form a contact surface for external wiring.

As shown in FIG. 6, the stationary contacts 206 are disposed along the middle position of the housing, and one ends of the stationary contacts 206 extend toward the body rotating shaft 202 located in the middle of the housing, so as to cooperate with movable contacts; the other ends of the stationary contacts 206 extend out of the housing and are bent to form the stationary contact plates 206a, and the stationary contact plates 206a are used as contact surfaces for external wiring. The stationary contact plates 206a may be directly led out from the middle of the housing or may be led out toward both sides (upper and lower sides in FIG. 6) of the housing.

For example, the left stationary contact plate 206a in FIG. 6 is led out from the lower portion of the housing, and the right stationary contact plate 206a is led out from the upper portion of the housing, so as to be wired with the screws 203 respectively.

In the prior art, taking FIG. 6 as an example, two stationary contacts are generally respectively disposed at the diagonal positions of the housing in FIG. 6. But in the present disclosure, two stationary contacts 206 are both disposed at the middle position of the housing, so that wiring is flexible from the middle position to both sides; there are many available wiring directions, and when the wiring direction is changed from the middle to both sides of the housing, the wiring path is also short. The stationary contacts 206 may be directly led out from the middle of the housing for wiring or led out from the middle and then wired to both sides, and the wiring path is the shortest no matter whether the stationary contacts 206 are led out from the middle of the housing and wired upward, or led out from the middle of the housing and wired downward in FIG. 6, so that the use amount of wiring materials is saved.

Thus, the wiring directions of the stationary contacts 206 of the switch unit 201 are separately located on both sides or at the middle position of the housing; when the plurality of layers of switch units 201 are stacked, the wiring direction can be selected according to specific requirements; exemplarily, in FIG. 7, screws 203a, 203b and 203c of stationary contacts 206 of three layers of switch units 201 for wiring are respectively located on the left side, middle, and right side of the housing, so as to allow wire outputs on the left side, middle, and right side, respectively.

In the plurality of layers of switch units 201 of the body module 21, the mounting surfaces of wiring terminals and the stationary contacts 206 are parallel to each other.

In one body module 21, the wiring terminals and the stationary contacts 206 of adjacent layers of switch units 201 are disposed at the same position and in parallel, and projections thereof in the stacking direction F2 overlap.

The plurality of layers of switch units 201 in the body module 21 are soldered. The plurality of layers of switch units 201 of the same body module 21 is formed by soldering housings of different layers, so that the soldering firmness is good, and the structural rigidity and the strength of the body module 21 can be ensured.

In another aspect, the embodiments of the present disclosure provide an isolating switch. The isolating switch includes a handle shaft 11, an operating mechanism 10 and at least one stage of isolating switch body 20 described above, which are linked in sequence.

The handle shaft 11 is used for being connected to a handle, and the operating mechanism 10 is driven to act by controlling the handle shaft 11 to rotate, so as to drive all the switch units 201 of the isolating switch body 20 to be opened and closed synchronously.

When a plurality of stages of isolating switch bodies 20 are provided, the plurality of stages of isolating switch bodies 20 are cascaded in a first direction F1, and the quantity of the cascaded stages of the isolating switch bodies 20 in the first direction F1 does not exceed three, so that synchronization is prevented from being affected by a large quantity of stages.

Exemplarily, as shown in FIG. 2 and FIG. 3, two stages of isolating switch bodies 20 are connected along the first direction F1, each isolating switch body 20 includes two body modules 21 located on both sides of a transmission mechanism 601, the body module 21 on one side includes three layers of switch units 201, and the body module 21 on the other side includes two layers of switch units 201.

The first stage of isolating switch body 20 is linked with the operating mechanism 10 through the transmission mechanism 601, and the transmission mechanism 601 is a four-bar linkage mechanism; adjacent stages of isolating switch bodies 20 are connected through another four-bar linkage mechanism, and the four-bar linkage mechanism includes a fifth connecting bar 104, a sixth connecting bar 105, a seventh connecting bar 106, and a virtual eighth connecting bar between the body rotating shafts 202 of the adjacent isolating switch bodies 20, so that the adjacent isolating switch bodies 20 act synchronously.

In the plurality of stages of isolating switch bodies 20, the two adjacent stages of isolating switch bodies 20 in the first direction F1 are clamped through grooves 204 and protrusions 205 on the housings of the switch units 201 outermost in the stacking direction F2, or are fixedly connected along the first direction F1 through screws.

The plurality of layers of switch units 201 are stacked on one isolating switch body 20 in the stacking direction F2, the two outermost switch units 201 in the plurality of layers of switch units 201 are provided with the grooves 204 or the protrusions 205, the two outermost switch units 201 in the adjacent isolating switch bodies 20 are correspondingly provided with the protrusions 205 or the grooves 204, and the two adjacent isolating switch bodies 20 are clamped through the matching of the grooves 204 and the protrusions 205.

Alternatively, two adjacent stages of isolating switch bodies 20 may also be fixedly connected along the first direction F1 through screws.

Further, the grooves 204 are T-shaped grooves, and the protrusions 205 are T-shaped protrusions. The T-shaped grooves and the T-shaped protrusions are arranged, so that the two adjacent isolating switch bodies 20 are clamped more firmly.

In addition, when a plurality of stages of isolating switch bodies 20 are disposed, and the plurality of stages of isolating switch bodies 20 are cascaded along the stacking direction F2, the linkage of the plurality of stages of isolating switch bodies 20 in the stacking direction F2 can be achieved by connecting one isolating switch body 20 through the transmission mechanism 601 and connecting the body rotating shaft 202 of each layer of switch unit 201 through a rotating shaft in the stacking direction F2.

In summary, in the isolating switch, the switch units 201 are arranged bidirectionally along the first direction F1 and the stacking direction F2, so that the synchronization among the switch units 201 can be effectively improved, and the function of the isolating switch can be further improved.

The isolating switch includes the same structure and beneficial effects as the isolating switch body 20 in the foregoing embodiments. The structure and the beneficial effects of the isolating switch body 20 have been described in detail in the foregoing embodiments, and are not described herein again.

One aspect of the embodiments of the present disclosure provides an isolating switch. As shown in FIG. 10, the isolating switch includes an operating mechanism 100 and a switch body 200, where the switch body 200 may be connected to a load circuit, and the operating mechanism 100 and the switch body 200 may be driven cooperatively, so that under the action of the operating mechanism 100, the switch body 200 may be driven to be opened and closed, and accordingly, the load circuit is turned on or off according to requirements. In the actual arrangement, the switch body 200 may be fixedly disposed on one side of a housing 110 where the operating mechanism 100 is located, and the fixing method may be detachable connection or non-detachable connection, for example, the detachable connection may be a plurality of methods such as screwing, clamping, and splicing.

As shown in FIG. 10 and FIG. 16 to FIG. 18, the operating mechanism 100 may rotate to drive a contact system in the switch body 200 to be opened or closed in a rotating manner, and the extension direction b of a rotation shaft of the operating mechanism 100 and the extension direction c of a rotation shaft of the switch body 200 may not overlap (e.g., be parallel or intersecting), so that the rotation shaft of the operating mechanism 100 and the rotation shaft of the switch body 200 may be prevented from forming a straight coaxial structure, and thus the isolating switch may have various forms, thereby reducing the limitation on installation and use of the isolating switch. For example, as shown in FIG. 10 and FIG. 16 to FIG. 18, the extension direction b of the rotation shaft of the operating mechanism 100 is parallel to the extension direction c of the rotation shaft of the switch body 200; for another example, the extension direction of the rotation shaft of the operating mechanism 100 intersects with the extension direction of the rotation shaft of the switch body 200, so that the isolating switch can avoid being restricted by the straight coaxial structure, and can meet the requirements of various installation and use environments in various new layout methods.

On this basis, when the extension direction of the rotation shaft of the operating mechanism 100 intersects with the extension direction of the rotation shaft of the switch body 200, further, the extension direction of the rotation shaft of the operating mechanism 100 and the extension direction of the rotation shaft of the switch body 200 are perpendicular to each other.

It should be understood that the term “perpendicular” or “parallel” in the present disclosure does not refer to absolute perpendicular or absolute parallel, and may be approximately perpendicular or approximately parallel. In addition, the opening and closing of the present disclosure include different states of opening, closing, etc.

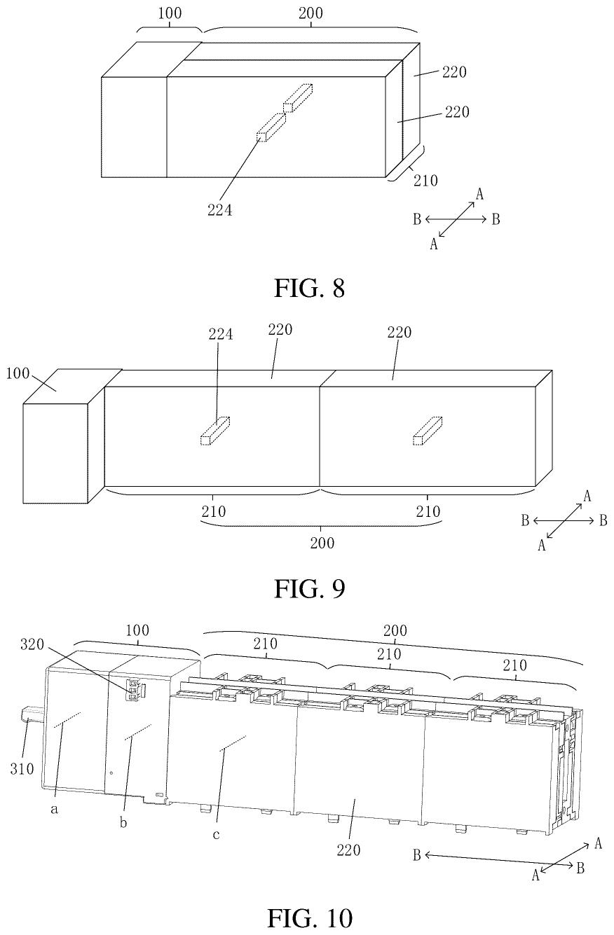

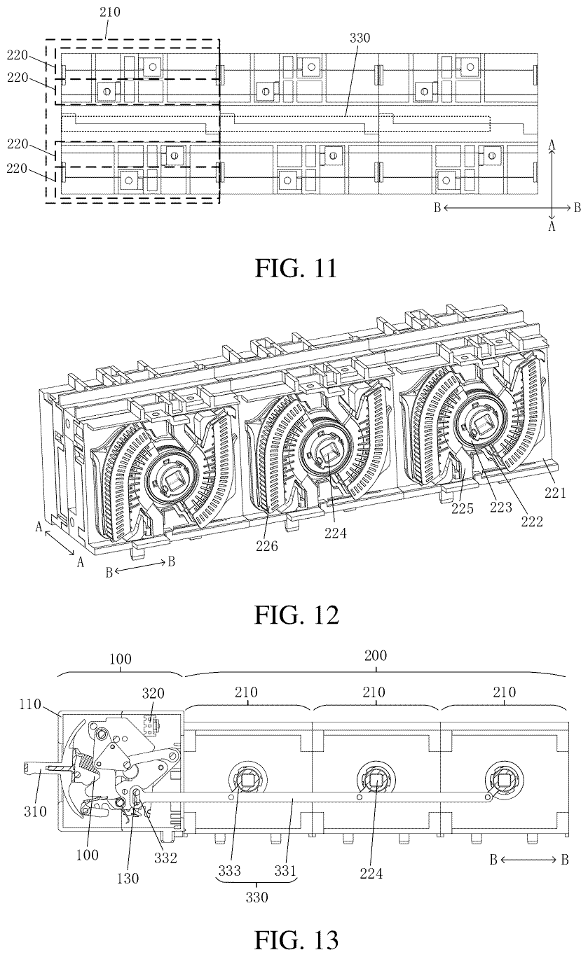

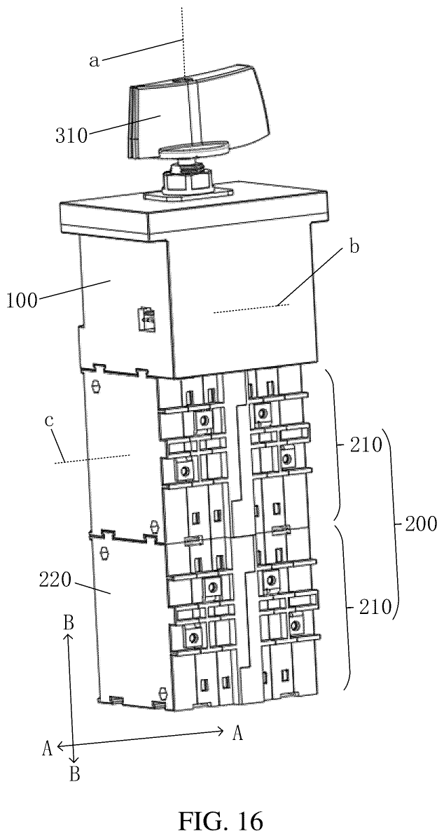

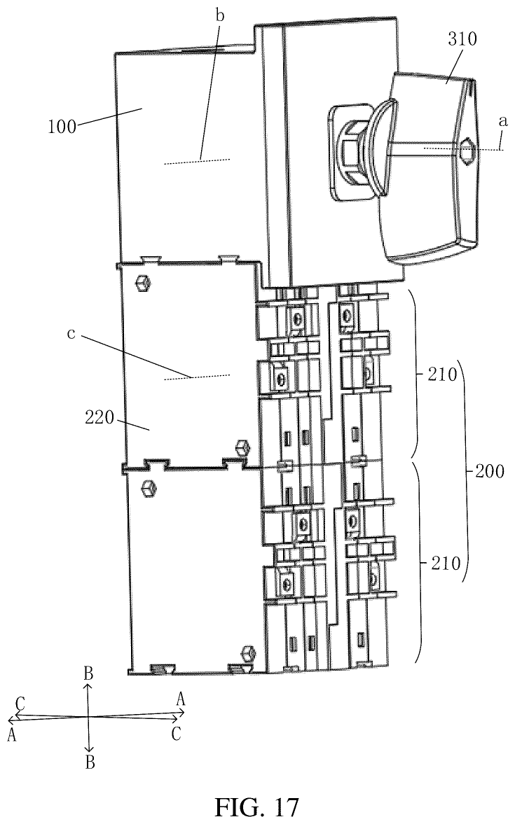

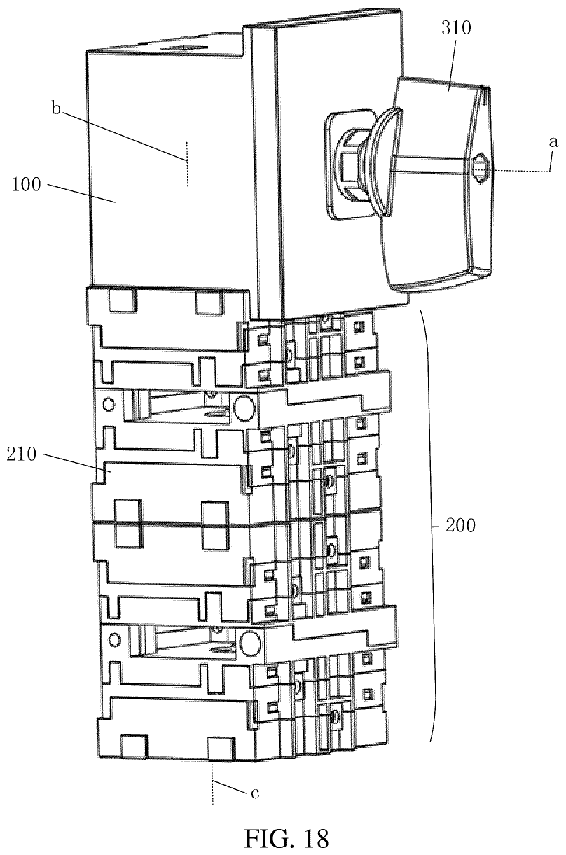

Optionally, the switch body 200 includes at least one switch assembly 210, and the switch assembly 210 includes at least one switch unit 220; specifically, referring to FIG. 8, the switch body 200 may be composed of the switch assemblies 210, and the quantity of the switch assemblies 210 may be at least one. The switch assembly 210 includes at least one switch unit 220, each switch unit 220 includes a contact system, the contact system includes a stationary contact 225 and a movable contact 222 that cooperate with each other to be opened and closed, and the movable contact 222 has a rotating shaft 224. For the same switch assembly 210, at least one switch unit 220 included therein may be stacked along the extension direction (i.e., the first direction A) of a rotation shaft of the switch assembly 210, thereby facilitating the rotating shafts 224 of the movable contacts 222 in the switch units 220 inside the same switch assembly 210 to be coaxial (e.g., the rotating shafts 224 of the movable contacts 222 in two switch units 220 in the switch assembly 210 shown in FIG. 8 to be coaxial), and accordingly, serving as the rotation shaft of the switch assembly 210. Of course, when the switch body 200 has one switch assembly 210, the rotation shaft of the switch assembly 210 is the rotation shaft of the switch body 200 (for example, as shown in FIG. 8, or as shown in FIG. 18, a plurality of switch units 220 are stacked along the same direction and divided into one switch assembly 210). However, when the switch body 200 has a plurality of switch assemblies 210, in order to facilitate the plurality of switch assemblies 210 to form a good driving connection to the operating mechanism 100, the rotation shafts of the plurality of switch assemblies 210 may be all in the same direction (for example, being parallel as shown in FIG. 9, FIG. 10, FIG. 16, or FIG. 17, or overlapped as shown when the plurality of switch units 220 are all stacked along the same direction and divided into two or more switch assemblies 210 shown in FIG. 11), and therefore, the rotation shaft of any one switch assembly 210 may be used as the rotation shaft of the switch body 200.

With the vigorous development of the photovoltaic industry, the intelligent demands for photovoltaic inverters are increasingly higher. When a photovoltaic circuit breaks down, the isolating switch serving as a key component with a breaking function must break the circuit in the shortest time to protect other components, so that the fact that the isolating switch has good breaking performance is of great significance to a load circuit to which the isolating switch is connected.

Therefore, in some embodiments, the switch body 200 may adopt a rectangular layout, that is, as shown in FIG. 9 to FIG. 13, FIG. 16 or FIG. 17, each switch body 200 includes two or more switch assemblies 210, the extension direction of the rotation shaft of each switch assembly 210 is the first direction A, at least two switch assemblies 210 are both stacked along the second direction B, and the first direction A and the second direction B are mutually perpendicular in space. Therefore, the quantity of switch units stacked on the same rotation shaft can be reduced on the basis of arranging the same quantity of switch units 220 by using the rectangular layout, thereby alleviating the problem of poor transmission consistency caused by an assembly clearance when the quantity of stacked layers of the switch units is large, and enabling the isolating switch to have better breaking consistency.

As shown in FIG. 8 to FIG. 10, FIG. 13, FIG. 16, or FIG. 17, when the rotation shaft of the switch body 200 or the rotation shaft of the switch assembly 210 extends in the first direction A, the operating mechanism 100 and the switch body 200 may be arranged in the second direction B, so that the arrangement direction of the operating mechanism 100 and the switch body 200 is perpendicular to the extension direction of the rotation shaft of the switch body 200, the rotating shaft 224 of the movable contact 222 extends in the first direction A perpendicular to the second direction B, and the driving connection between the operating mechanism 100 and each switch assembly 210 is facilitated.

For the switch assemblies 210 in the switch body 200, the quantity of the switch assemblies may be at least one. Specifically: for example, as shown in FIG. 8, an isolating switch is provided, where the switch body 200 includes a switch assembly 210 stacked with the operating mechanism 100 along the second direction B, and movable contacts 222 of switch units 220 in the switch assembly 210 and the operating mechanism 100 establish a drive, so that under the action of the operating mechanism 100, the switch assembly 210 can be driven to be opened or closed. For another example, as shown in FIG. 9, an isolating switch is provided, where the switch body 200 includes an operating mechanism 100 and two switch assemblies 210 stacked along the second direction B, and the operating mechanism 100 is separately in driving connection to movable contacts 222 of switch units 220 in the two switch assemblies 210, so that under the action of the operating mechanism 100, the two switch assemblies 210 can be driven to be synchronously opened or closed. For yet another example, as shown in FIG. 10 and FIG. 11, an isolating switch is provided, where the switch body 200 includes an operating mechanism 100 and three switch assemblies 210 stacked along the second direction B, and the operating mechanism 100 is separately in driving connection to movable contacts 222 of switch units 220 in the three switch assemblies 210, so that under the action of the operating mechanism 100, the three switch assemblies 210 can be driven to be synchronously opened or closed.

For the switch units 220 in the switch assembly 210, the quantity of the switch units may be at least one. Specifically: for example, as shown in FIG. 9, an isolating switch is provided, where for the same switch assembly 210, the switch assembly includes a switch unit 220 arranged along the first direction A, the operating mechanism 100 is in driving connection to a movable contact 222 of the switch unit 220 in the switch assembly 210, so that under the action of the operating mechanism 100, the one switch unit 220 in the switch assembly 210 can be driven to be opened or closed. For another example, as shown in FIG. 8, an isolating switch is provided, where for the same switch assembly 210, the switch assembly includes two switch units 220 stacked along the first direction A, each switch unit 220 can be connected to one circuit, and the operating mechanism 100 is separately in driving connection to movable contacts 222 of the two switch units 220 in the switch assembly 210, so that under the action of the operating mechanism 100, the two switch units 220 in the switch assembly 210 can be driven to be synchronously opened or closed. For yet another example, as shown in FIG. 10 and FIG. 11, an isolating switch is provided, where for the same switch assembly 210, the switch assembly includes four switch units 220 stacked along the first direction A, each switch unit 220 can be connected to one circuit, and the operating mechanism 100 is separately in driving connection to movable contacts 222 of the four switch units 220 in the switch assembly 210, so that under the action of the operating mechanism 100, the four switch units 220 in the switch assembly 210 can be driven to be synchronously opened or closed.

In order to simplify the transmission structure and ensure better opening and closing consistency at the same time, when the switch assembly 210 includes a plurality of switch units 220 stacked along the first direction A (for example, FIG. 8, FIG. 11, FIG. 16, or FIG. 17), the rotating shafts 224 of the movable contacts 222 of at least two switch units 220 in the same switch assembly 210 may be coaxially nested and transmitted along the first direction A, so that the operating mechanism 100 may drive only the closest switch unit 220, and the remaining switch units 220 may be driven to be synchronously opened or closed through the coaxial nesting. The rotating shafts 224 of two switch units 220 coaxially nested in the same switch assembly 210 may establish a transmission relationship of rotation around the shaft in a manner of inserting a prism hole and the end portion of a prism, for example, the rotating shaft 224 of the movable contact 222 is a square shaft, one end portion of each square shaft has a square hole, and the other end portion is a square shaft, so that the rotating shafts 224 of the movable contacts 222 in two adjacent switch units 220 can perform transmission around the shaft in a manner of inserting the square shaft and the square hole.

The contact system inside each switch unit 220 of the present disclosure may only include a group of mutually cooperating movable and stationary contacts 225 (each group includes only one stationary contact 225 and one movable contact 222), or may include two, three, or more groups of mutually cooperating movable and stationary contacts 225. According to different quantities of groups, the corresponding connected circuit can form a single-break point, a double-break point, a triple-break point, or a multi-break point when being disconnected, which is not limited in the present disclosure and can be correspondingly set according to the actually applicable scenes for the switch body 200 so as to meet different performance requirements. It should be noted that, when the mutually cooperating movable and stationary contacts 225 are divided in a group form, the division is only performed from the aspect of the cooperation relationship, and does not represent the mutual separation of the actual structures. For example, as shown in FIG. 12 and FIG. 13, two movable contacts 222 in two groups of movable and stationary contacts 225 may be integrated into the same movable contact support 223, so as to form a structural member, two end portions of the middle structural member may be respectively used as two movable contacts 222, one of which cooperates with the upper stationary contact 225, and the other cooperates with the lower stationary contact 225, so that a double-break point structure is formed, and an intermediate shaft of the structural member is used as the rotating shafts 224 of the movable contacts 222 in the switch unit 220 to be in cooperative drive with the operating mechanism 100.

Referring to FIG. 12, the switch unit 220 of the present disclosure may include a unit housing 221, a contact system, and arc extinguishing chambers 226, where the contact system and the arc extinguishing chambers 226 are both distributed in the unit housing 221, and the quantity of the arc extinguishing chambers 226 may be correspondingly matched according to the quantity of break points of the contact system; for example, in FIG. 12, the contact system includes two groups of mutually cooperating movable and stationary contacts 225, so that the two arc extinguishing chambers 226 may respectively cooperate with arc generating regions of the two groups of movable and stationary contacts 225, thereby improving the arc extinguishing capability.

When the driving connection between the operating mechanism 100 and the movable contacts 222 in the switch unit 220 is achieved, as shown in FIG. 11 to FIG. 14, the isolating switch further includes a transmission member 330, the transmission member 330 extends along the second direction B, so that the operating mechanism 100 is conveniently in driving connection to the switch assemblies 210 stacked along the second direction B through the transmission member 330. Specifically, the transmission member 330 extends along the second direction B and is sequentially in driving connection to the rotation shafts of the switch assemblies 210, so that the operating mechanism 100 can synchronously open or close all the switch assemblies 210 through the transmission member 330, and thus, the isolating switch of the present disclosure has better breaking consistency, and the breaking performance of the isolating switch is effectively improved.

In some embodiments, when the switch body 200 includes a plurality of switch assemblies 210, the plurality of switch assemblies 210 may be distributed on the same side of the transmission member 330.

In some embodiments, when the switch body 200 includes a plurality of switch assemblies 210, the plurality of switch assemblies 210 may be distributed on opposite sides of the transmission member 330, specifically, may be uniformly distributed or non-uniformly distributed.

Correspondingly, when the switch body 200 includes a plurality of switch assemblies 210 and the plurality of switch assemblies 210 are distributed on the same side or opposite sides of the transmission member 330, the plurality of switch units 220 included in each switch assembly 210 are distributed on the same side of the transmission member 330.

Of course, in still other embodiments, as shown in FIG. 11, the transmission member 330 may pass through the inside of the switch assembly 210, that is, the switch units 220 in the switch assemblies 210 are distributed on opposite sides of the transmission member 330, so that the forces on the opposite sides of the transmission member 330 can be effectively balanced, and the transmission of the transmission member 330 is more stable.

In order to further improve the transmission smoothness, the plurality of switch units 220 included in each switch assembly 210 are symmetrically distributed on opposite sides of the transmission member 330, in other words, the quantities of the switch units 220 distributed on opposite sides of the transmission member 330 in the same switch assembly 210 are equal. For example, as shown in FIG. 11, the switch body 200 includes three switch assemblies 210 stacked along the second direction B, each switch assembly 210 includes four switch units 220 stacked along the first direction A, two of the four switch units 220 are located on the upper side of the transmission member 330, and the other two switch units are located on the lower side of the transmission member 330, so that when the transmission member 330 distributed in the middle drives the movable contacts 222 of the switch units 220 in the switch assemblies 210 to move, better balance is achieved, and the opening and closing consistency of the isolating switch is improved.

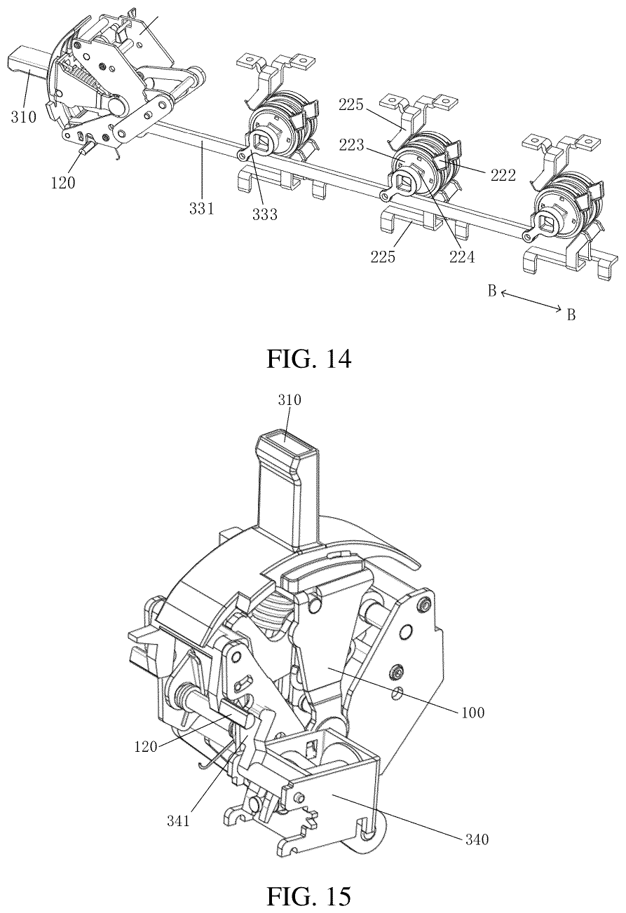

In some embodiments, the transmission member 330 includes a translational portion and a rotary portion 333 which are connected to each other, and a plurality of rotary portions 333 may be provided. For example, in FIG. 13 and FIG. 14, three rotary portions 333 are provided, the three rotary portions 333 are respectively connected to the rotating shafts 224 of the three switch assemblies 210, one end of the translational portion is connected to the operating mechanism 100, and the translational portion extends along the second direction B, so that the translational portion is sequentially connected to the plurality of rotary portions 333 arranged along the second direction B, and thus, the operating mechanism 100 can be in driving connection to the rotation shafts of the switch assemblies 210 sequentially through the translational portion and the rotary portions 333.

During actual driving, the operating mechanism 100 can drive the translational portion to translate, so as to generate a displacement component along the second direction B, and thus, the translational portion drives the rotation shafts of the switch assemblies 210 to rotate through the rotary portions 333, thereby achieving the purpose that the movable contacts 222 and the stationary contacts 225 are opened or closed through rotation.

In some embodiments, as shown in FIG. 13 and FIG. 14, the translational portion is a connecting bar 331, one end of the connecting bar 331 is connected to the operating mechanism 100, the connecting bar 331 is separately hinged to the rotary portions 333 in sequence by using the extension length thereof along the second direction B, and the rotary portions 333 sleeve the rotating shafts 224 of the movable contacts 222 in a shaft-hole cooperation manner, so that when the operating mechanism 100 drives the connecting bar 331 to generate a displacement component along the second direction B, the movable contacts 222 can be driven to rotate around the rotating shafts 224 through the rotary portions 333.

In some embodiments, as shown in FIG. 13, a kidney-shaped hole 332 is formed at an end portion of the connecting bar 331, and a driving end 130 of the operating mechanism 100 is slidably connected to the kidney-shaped hole 332, so that interference that may occur among the operating mechanism 100, the transmission member 330, and the rotating shafts 224 of the movable contacts 222 can be effectively balanced by using the kidney-shaped hole 332, and the smoothness and stability of transmission can be improved.

In some embodiments, the translational portion may also be a rack, the rotary portion 333 may be a gear meshing with the rack, the operating mechanism 100 is in driving connection to the rack, and the gears are fixedly disposed with the rotating shafts 224 of the movable contacts 222, so that when the gears mesh with the rack, the operating mechanism 100 can be used to drive the rack to generate displacement, and then drive the gears and the rotating shafts 224 rotate synchronously, thereby achieving the rotary opening and closing of the movable contacts 222.

In order to improve the operability of the isolating switch, as shown in FIG. 10 to FIG. 18, the isolating switch may further include a handle 310, the handle 310 is in driving connection to the operating mechanism 100, and the operating end of the handle 310 extends outside a housing 110 for accommodating the operating mechanism 100, so as to facilitate the actual use of a user. When the handle 310 is arranged, the handle 310 and the operating mechanism 100 may be arranged along the first direction A or the second direction B, so as to form different operation modes of front-side operation or lateral operation. During the actual arrangement, adaptive selection and adjustment are performed according to actual installation and use environments, so as to meet installation and use in different environments.

Specifically, for example, as shown in FIG. 10, FIG. 13, and FIG. 16: the handle 310, the operating mechanism 100, and the switch body 200 are arranged along the second direction B, so that the isolating switch can form a front-side operation structure, and the user can conveniently operate the isolating switch on the front side. In addition, the isolating switch may also be configured to be operated laterally, that is, the operating mechanism and the switch body may still be arranged along the second direction B, and the handle and the operating mechanism may be arranged along a direction perpendicular to the second direction B, for example, the first direction or a third direction, where the first direction, the second direction B, and the third direction are perpendicular to each other in space. For example, as shown in FIG. 17: the handle 310 and the operating mechanism 100 are arranged along the third direction C, and the operating mechanism 100 and the switch body 200 are arranged along the second direction B, so that the isolating switch is L-shaped as a whole, a lateral operation structure is formed, and the user can conveniently operate the isolating switch from the side. In addition, the handle 310 and the operating mechanism 100 may also be arranged along the first direction A, and accordingly, a lateral operation structure can also be correspondingly formed. For another example, as shown in FIG. 18: the arrangement direction of the handle 310 and the operating mechanism 100 is perpendicular to the arrangement direction of the operating mechanism 100 and the switch body 200, so that the isolating switch is L-shaped as a whole, a lateral operation structure is formed, and the user can conveniently operate the isolating switch from the side.

In some embodiments, the handle 310 may also adopt a rotary action manner, that is, the user may drive the handle 310 to rotate around the own rotation shaft, so as to drive the operating mechanism 100 and the switch body 200 to rotate. During the actual arrangement, as shown in FIG. 10, the extension direction a of the rotation shaft of the handle 310 is parallel to the extension direction b of the rotation shaft of the operating mechanism 100. Of course, further, the extension direction a of the rotation shaft of the handle 310 may also be parallel to a rotation shaft c of the switch body 200, and the extension direction a of the rotation shaft of the handle 310 may also be perpendicular to the stacking direction (that is, the second direction B) of the operating mechanism 100 and the switch body 200. In addition, as shown in FIG. 16 to FIG. 18, the extension direction a of the rotation shaft of the handle 310 may also be perpendicular to the extension direction b of the rotation shaft of the operating mechanism 100. Of course, further, the extension direction a of the rotation shaft of the handle 310 may also be perpendicular to the rotation shaft c of the switch body 200. In FIG. 16, the extension direction a of the rotation shaft of the handle 310 is also the same as the stacking direction (i.e., the second direction B) of the operating mechanism 100 and the switch body 200. In FIG. 17, the extension direction a of the rotation shaft of the handle 310 is also perpendicular to the stacking direction (i.e., the third direction C) of the operating mechanism 100 and the switch body 200. In FIG. 18, the extension direction a of the rotation shaft of the handle 310 is also perpendicular to the stacking direction of the operating mechanism 100 and the switch body 200.

In some embodiments, as shown in FIG. 15, a release 340 may be further disposed on one side of the operating mechanism 100, the release 340 has a driving portion 341, and the operating mechanism 100 has a driven portion 120, so as to facilitate the release 340 to establish a driving relationship with the operating mechanism 100 through the driving portion 341 and the driven portion 120. When there is a circuit fault, the driving portion 341 of the release 340 can drive the driven portion 120 to move, so that the operating mechanism 100 is released and opened, and turns off the circuit in time. As shown in FIG. 15, a gap may be formed between the driving portion 341 and the driven portion 120, so that when the release 340 acts, the driving portion 341 may first buffer by using the gap and then act on the driven portion 120 of the operating mechanism 100, thereby driving the operating mechanism 100 to be released and opened. Through forming the gap, the phenomenon that a current isolating switch is not released with a fault, or is unexpectedly released without a fault can be effectively solved.

In some embodiments, as shown in FIG. 10 and FIG. 13, the isolating switch further includes a signal terminal 320, and the signal terminal 320 is electrically connected to the release 340, so that the signal terminal 320 can transmit a command to the release 340, and therefore, the release 340 can drive the operating mechanism 100 in time to be released and opened, that is, the remote breaking control of the isolating switch is achieved.

In some embodiments, as shown in FIG. 14 and FIG. 15, the operating mechanism 100 may be accommodated inside the housing 110, and meanwhile, the forgoing handle 310, the release 340, and the signal terminal 320 may be disposed inside the housing 110 in a matching manner, and the operating mechanism 100 is a four-bar linkage mechanism, so that the four-bar linkage mechanism may be used to better match the layout of the isolating switch of the present disclosure, and on the basis of ensuring the breaking consistency of the isolating switch, the stability of opening and closing can be effectively improved, and the research and development cycle can be shortened. The present disclosure does not particularly limit the specific structure of the four-bar linkage mechanism. Of course, in other embodiments, the operating mechanism 100 may also adopt a rotary energy storage mechanism, or a five-bar linkage mechanism, a six-bar linkage mechanism, or other various forms.

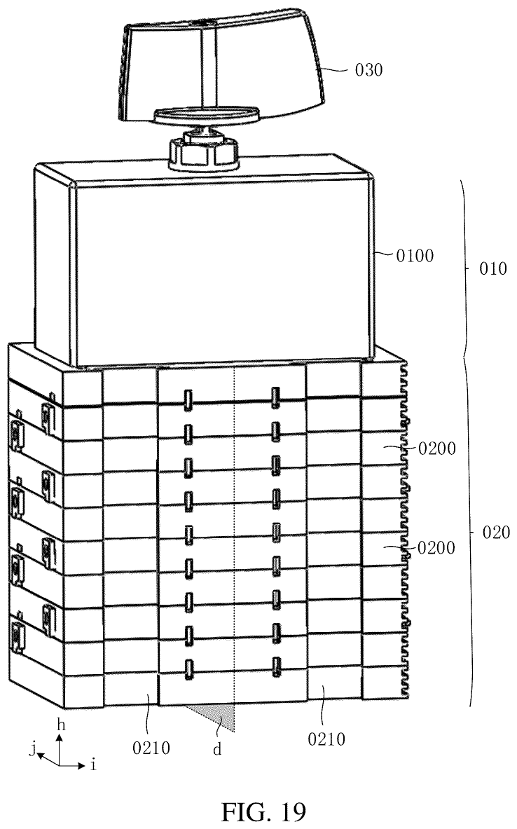

One aspect of the embodiments of the present disclosure provides an isolating switch. As shown in FIG. 19, the isolating switch includes an operating mechanism 010 and a switch body 020, where the switch body 020 may be connected to a load circuit, and the operating mechanism 010 and the switch body 020 may be driven cooperatively, so that under the action of the operating mechanism 010, the switch body 020 may be driven to be opened and closed, and accordingly, the load circuit is turned on or off according to requirements. In the actual arrangement, the switch body 020 may be fixedly disposed on one side of a housing where the operating mechanism 010 is located, and the fixing method may be detachable connection or non-detachable connection, for example, the detachable connection may be a plurality of methods such as screwing, clamping, and splicing.

With continued reference to FIG. 19, the switch body 020 may include at least one layer of switch assembly 0200, that is, the quantity of the layers of switch assemblies 0200 may be one layer or a plurality of layers, and the plurality of layers include two layers or more. Therefore, when a plurality of layers of switch assemblies 0200 are provided, the plurality of layers of switch assemblies 0200 may be stacked along a first direction, so that the isolating switch can have a capability of being connected to a plurality of load circuits.

On this basis, each switch assembly 0200 includes a plurality of switch units 0210 arranged on the same layer, and the plurality includes two or more. Each switch unit 0210 may include a contact system that can be switched between closing and opening, so that the closed and open states of the contact system represent the closed and open states of the switch unit 0210 to which the contact system belongs, and when the operating mechanism 010 is in driving connection to the switch unit 0210, that is, the operating mechanism 010 is in driving connection to the contact system included in the switch unit 0210, the movable contact 0213 system is driven by the operating mechanism 010 to be switched between closing and opening.

In order to enable all the switch units 0210 in the switch body 020 to have consistent open and closed states, all the switch units 0210 in each layer of switch assembly 0200 can be in driving connection to the operating mechanism 010, and under the driving of the operating mechanism 010, synchronous closing and synchronous opening can be achieved.

With continued reference to FIG. 19, each layer of switch assembly 0200 includes a plurality of switch units 0210 arranged on the same layer, so that the switch body 020 can be stacked and extend in the first direction through the switch assemblies 0200, and can also extend in a direction perpendicular to the first direction through the plurality of switch units 0210 in each layer of switch assembly 0200, thereby effectively reducing the length of the switch body 020 in the first direction and alleviating the limitation on installation and use of the isolating switch.

For example, as shown in FIG. 19, the plurality of layers of switch assemblies 0200 are stacked along a first direction h, each layer of switch assembly 0200 is composed of two switch units 0210, and the two switch units 0210 are arranged along a second direction i perpendicular to the first direction h. For a clearer understanding of the present disclosure, as shown in FIG. 19, a plane d is introduced (the plane d is only used for a virtual reference introduced for understanding the solution of the present disclosure and is not embodied in an actual product structure, and therefore, it should not be understood as a limitation to the present disclosure), and two switch units 0210 included in each layer of switch assembly 0200 are divided by the plane d, where a portion of the switch assembly 0200 located on the left side of the plane d is used as one switch unit 0210, and a portion of the switch assembly 0200 located on the right side of the plane d is used as another switch unit 0210, and thus, the two switch units 0210 are arranged on the same layer along the second direction i, so that the switch body 020 has a length in the first direction h, and also extends toward the second direction i through the switch units 0210 distributed on the same layer, thereby reducing the length of the switch body 020 in the first direction. For the equal quantity of switch units 0210, the length of the switch body 020 in the first direction can be reduced by half by adopting the layout solution of the present disclosure.

On this basis, for the plurality of switch units 0210 arranged on the same layer and included in the same switch assembly 0200, at least two switch units 0210 are connected in series inside the switch assembly 0200, in other words, the contact systems of at least two switch units 0210 are connected in series inside the switch assembly 0200. Of course, the quantity of switch units connected in series in the plurality of switch units 0210 arranged on the same layer is not limited in the present disclosure, for example, two switch units 0210 may be connected in series, or three switch units 0210 may be connected in series, which is specifically determined comprehensively according to the quantity of the switch units 0210 included in the switch assembly 0200 and the breaking voltage required to be satisfied, but it can be understood that the breaking voltage is correspondingly increased as the quantity of the switch units 0210 connected in series to the same link becomes larger.

Referring to FIG. 19, taking two switch units 0210 being connected in series as an example: the two switch units 0210 connected in series can be connected to the same load circuit, and break points can be respectively formed at the contact systems of the two switch units 0210 connected in series during breaking, so that the breaking voltage can be effectively improved. Moreover, since the series connection is already completed inside the switch assembly 0200, for the switch units 0210 connected in series, wiring is not needed during a wiring stage of a user, so that the quantity of external interfaces is reduced, and the wiring difficulty and the risk of external breakdown are reduced. Taking FIG. 19 as an example, each layer of switch assembly 0200 includes two switch units 0210, and the two switch units 0210 are connected in series inside the switch assembly 0200. Therefore, compared with the prior art in which two switch units 0210 have four external interfaces, the present disclosure has only two external interfaces, which can reduce half of the external interfaces, thereby effectively reducing the quantity of the external interfaces.

Optionally, for all the switch units 0210 on the same layer: the switch units 0210 connected in series to the same link form a series connection group. Therefore, when the switch assembly 0200 includes four or more switch units 0210, two or more series connection groups can be formed, the relationship between a plurality of series connection groups may be parallel connection, series connection, or parallel connection and series connection, of course, which is not limited in the present disclosure and can be reasonably selected and set according to actual circuit requirements.

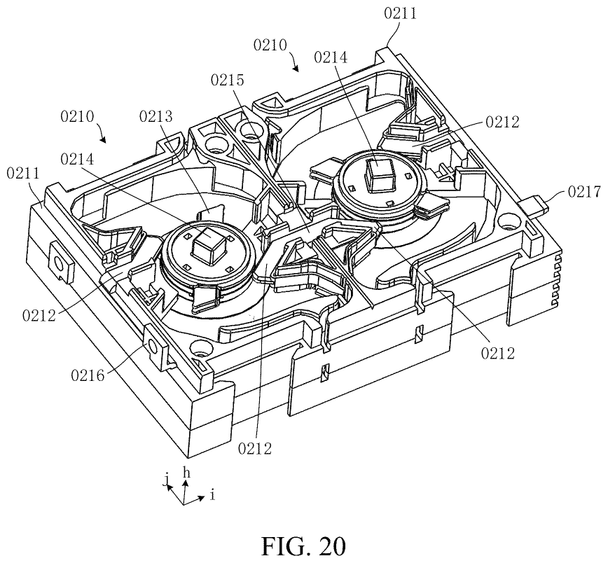

Optionally, in the plurality of switch units 0210 located on the same layer, the switch units 0210 connected in series may be adjacent, so that the wiring length of the internal serial connection can be reduced, and the difficulty of the internal serial connection can also be reduced. For example, as shown in FIG. 20, each switch unit 0210 includes a unit housing 0211, and a movable contact 0213 and stationary contacts 0212 which are located in the unit housing 0211, the operating mechanism 010 is in driving connection to the movable contact 0213, so that the movable contact 0213 and the stationary contacts 0212 can be driven to be opened or closed cooperatively under the driving of the operating mechanism 010; the unit housings 0211 of the two switch units 0210 connected in series are adjoined, and the stationary contacts 0212 of the two switch units 0210 connected in series are short-circuited at an adjoined position 0215 of the unit housings.

It should be understood that, when the contact system in the switch unit 0210 is broken, the break points included may be a single-break point, a double-break point, a triple-break point, etc., which is not limited in the present disclosure. For example, as shown in FIG. 20, the contact system is in a double-break point form, that is, a movable contact 0213 and two stationary contacts 0212 located beside the movable contact 0213 are arranged in the unit housing 0211, during closing, the movable contact 0213 is separately in contact with the two stationary contacts 0212, and during opening, the movable contact 0213 is separated from the two stationary contacts 0212, so that two break points are formed between the movable contact 0213 and the two stationary contacts 0212, thereby increasing the breaking voltage. Therefore, in the double-break point contact system, one stationary contact 0212 of the left switch unit 0210 and one stationary contact 0212 of the right switch unit 0210 are short-circuited at the adjoined position 0215 of the left and right unit housings, so that the two contact systems are connected in series.

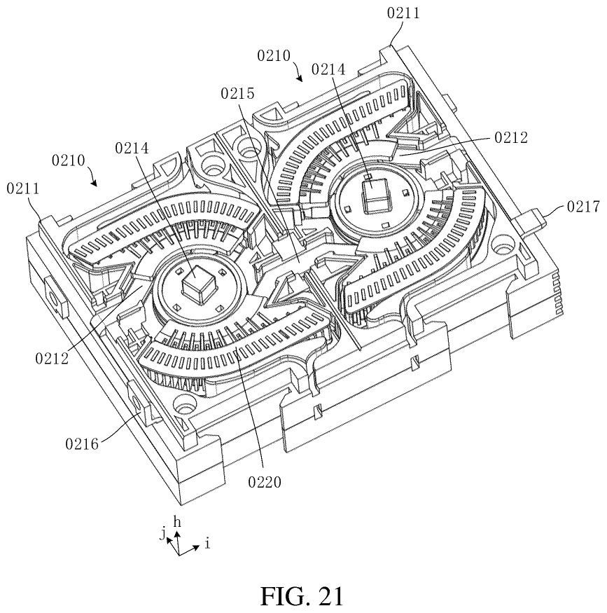

Optionally, the switch unit 0210 may further include arc extinguishing apparatuses 0220, as shown in FIG. 21, the arc extinguishing apparatuses 0220 are disposed in the unit housing 0211, and the arc extinguishing apparatuses 0220 may be located on a moving path of the movable contact 0213, so that in the breaking process of the contact system, the arc extinguishing apparatuses 0220 perform timely arc extinguishing on an electric arc that may be generated. The arc extinguishing apparatuses 0220 may be set according to the quantity of break points, that is, one arc extinguishing apparatus 0220 user performs arc extinguishing on a circuit generated by one break point. The arc extinguishing apparatuses 0220 may be grid arc extinguishing chambers.

Optionally, in order to facilitate the isolating switch to be connected to the circuit, as shown in FIG. 20, the stationary contact 0212 in the contact system may extend toward the outside of the unit housing 0211, the end portion extending serves as an external interface, the external interface may be divided into a wiring terminal 0216 and a plug-in terminal 0217 according to different wiring forms; as shown in FIG. 20, the end portion of the stationary contact 0212 of the left switch unit 0210 that extends to the outside of the unit housing 0211 serves as the wiring terminal 0216, which can achieve wiring by a screw, and the end portion of the stationary contact 0212 of the right switch unit 0210 that extends to the outside of the unit housing 0211 serves as the plug-in terminal 0217, which can directly meet onboard use requirements in a plug-in manner, for example, being plugged into an external circuit board 040.

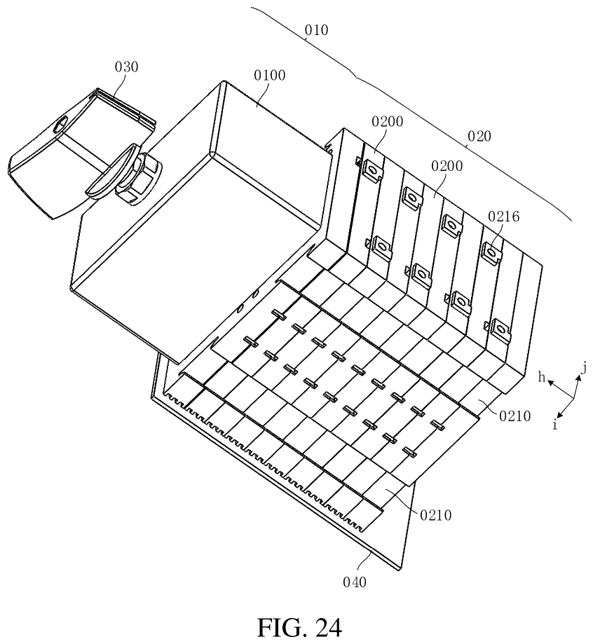

According to different wiring scenes where the isolating switch is applied, the wiring terminal 0216 and the plug-in terminal 0217 can be disposed as required, for example, when both sides of the isolating switch need to be wired by the user, the wiring terminals 0216 can be respectively disposed on opposite sides of the switch body 020, in other words, the wiring terminals 0216 are respectively disposed on opposite sides of the switch assembly 0200, so as to serve as the external interfaces, and when the user performs wiring, wires can be respectively connected to the wiring terminals 0216 on opposite sides of the switch assembly 0200. For another example, as shown in FIG. 24, when the isolating switch needs to be applied to scenes of an onboard switch, the plug-in terminal 0217 may be disposed on one side of the switch body 020, so that the isolating switch is conveniently soldered to the circuit board 040 through the plug-in terminal 0217, specifically, the circuit board 040 may be plugged on one side of the isolating switch; when the user only needs to perform wiring on the other side of the isolating switch, the plug-in terminal 0217 may be distributed on one side of the switch body 020, and the wiring terminal 0216 may be distributed on the other side. During installation, the isolating switch is connected to the circuit board 040 through the plug-in terminal 0217 distributed on one side in a plug-in manner, and the user connects the wire to the wiring terminal 0216 distributed on the other side of the isolating switch.

Optionally, the switch unit 0210 has a rotation shaft in driving connection to the operating mechanism 010, and the contact system in the switch unit 0210 can be driven to be switched between closing and opening by the rotation of the rotation shaft.

For a plurality of switch units 0210 distributed on the same layer: the rotation shafts 0214 of the plurality of switch units located on the same layer are parallel to each other (certainly, including being approximately parallel), the coaxial arrangement of the switch units 0210 arranged on the same layer can be avoided, and therefore, the quantity of the switch units 0210 which are stacked to the same rotation shaft in the first direction can be reduced by matching with the foregoing arrangement mode of the switch body 020, and accordingly, the problem of poor transmission consistency caused by assembly clearances when the quantity of the stacked switch units 0210 is large can be relieved, and the isolating switch has good breaking consistency.

Taking FIG. 20 as an example, the internal structure of a certain layer of switch assembly 0200 is shown, the switch assembly 0200 includes two switch units 0210, each switch unit 0210 has a contact system and a rotation shaft for driving the movable contact 0213 system to be closed and opened, the rotation shafts 0214 of the two switch units are parallel to each other, i.e. are not coaxially arranged, and the operating mechanism 010 can be in driving connection to the rotation shafts 0214 of the two switch units during driving.

For the switch units 0210 distributed on different layers: when the switch body 020 includes a plurality of layers of switch assemblies 0200, the quantity of the switch units 0210 in each layer of switch assembly 0200 may be the same, so that the switch units 0210 in adjacent two layers of switch assemblies 0200 can be stacked in one-to-one correspondence along the first direction, and the rotation shafts 0214 of the switch units in stacked correspondence along the first direction in the plurality of layers of switch assemblies 0200 are coaxially arranged, so that the operating mechanism 010 can conveniently drive the coaxially-arranged switch units 0210 to be synchronously opened or closed. For example, as shown in FIG. 19, each layer of switch assembly 0200 is divided into switch units 0210 (two in total) arranged in left and right by the plane d, adjacent layers of switch assemblies 0200 have the switch units 0210 located on the left side of the plane d, and the two switch units 0210 are in stacked correspondence along the first direction h, so that the switch units 0210 located on the left side of the plane d in all the switch assemblies 0200 are in stacked correspondence along the first direction h to form a stacked body located on the left side of the plane d, and the switch units 0210 located on the right side of the plane d can also form a stacked body located on the right side of the plane d in the same way, and the stacked bodies located on the left and right sides of the plane d jointly constitute the switch body 020. Moreover, the rotation shafts 0214 of the switch units in the stacked body located on the left side of the plane d are coaxially arranged, and the case in the stacked body located on the right side of the plane d is in a similar way, so that the driving connection of the operating mechanism 010 and the rotation shafts 0214 of all the switch units can be simplified.

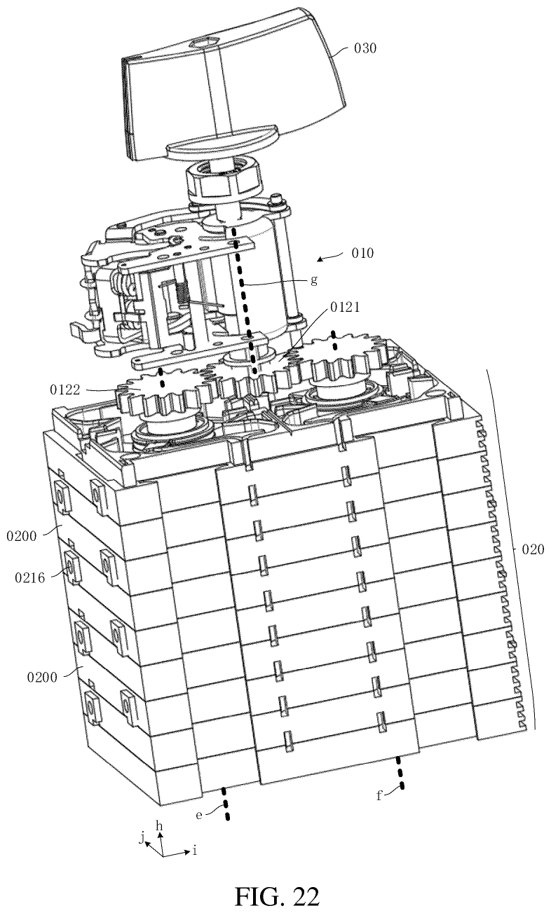

Optionally, the axis of the rotation shaft of the operating mechanism 010 does not overlap with the axis of the rotation shaft 0214 of any switch unit, specifically, the axis of the rotation shaft of the operating mechanism 010 is parallel or perpendicular to the axis of the rotation shaft 0214 of the switch unit. For example, as shown in FIG. 22, the rotation shafts 0214 of the switch units included in the stacked body located on the left side of the plane d are coaxially arranged, and therefore, have a common axis e, and similarly, the rotation shafts 0214 of the switch units included in the stacked body located on the right side of the plane d are coaxially arranged, and therefore, have a common axis f; the axis e and the axis f are parallel to each other, the axis of the rotation shaft of the operating mechanism 010 is an axis g, and the axis g is parallel to the axis e and the axis f separately.

Optionally, in order to facilitate the driving connection of the operating mechanism 010 and the switch units 0210, the isolating switch further includes a transmission assembly, i.e., the operating mechanism 010 may be in driving connection to the rotation shafts 0214 of the switch units through the transmission assembly. For ease of understanding, two embodiments are given schematically below:

In an embodiment, referring to FIG. 22, the transmission assembly includes a first transmission gear 0121 and a plurality of second transmission gears 0122 meshing with the first transmission gear 0121, the operating mechanism 010 is in driving connection to the first transmission gear 0121, so that the operating mechanism 010 can drive the first transmission gear 0121 to rotate, and the plurality of second transmission gears 0122 are in one-to-one corresponding driving connection to the rotation shafts 0214 of the switch units located on the same layer. Therefore, when the operating mechanism 010 is driven by an external force, the plurality of second transmission gears 0122 can be driven by the first transmission gear 0121 to rotate synchronously, and further the rotation shafts 0214 of the switch units on the same layer are driven to rotate synchronously, so that the switch units 0210 on the same layer are synchronously opened or closed.

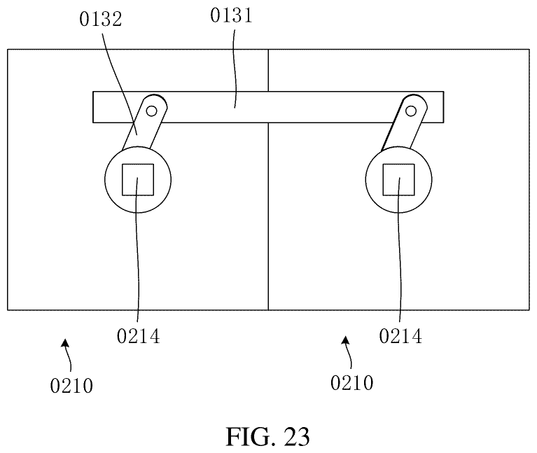

In another embodiment, referring to FIG. 23, the transmission assembly includes a transmission rod 0131 and a plurality of transfer members 0132 rotationally connected to the transmission rod 0131, the transmission rod 0131 is in driving connection to the operating mechanism 010, and the plurality of transfer members 0132 are in one-to-one corresponding driving connection to the rotation shafts 0214 of the switch units located on the same layer. Therefore, when the operating mechanism 010 is driven by an external force, the transfer members 0132 can be driven by the transmission rod 0131 to move, and the rotation shafts 0214 of the switch units on the same layer are driven by the transfer members 0132 to synchronously rotate, so that the switch units 0210 on the same layer are synchronously opened or closed.

Optionally, as shown in FIG. 19, the operating mechanism 010 and the switch body 020 may be stacked along the first direction h. Of course, in other examples, the operating mechanism 010 and the switch body 020 may also be arranged along a second direction perpendicular to the first direction.

Optionally, as shown in FIG. 19, the isolating switch further includes a handle 030, and the handle 030 is in driving connection to the switch units 0210 in the switch body 020 through the operating mechanism 010.

In specific arrangement, as shown in FIG. 19, the handle 030, the operating mechanism 010, and the switch body 020 may be sequentially arranged along the first direction, so that the user can conveniently operate the isolating switch at the front. Of course, the handle 030 and the operating mechanism 010 may also be arranged along a direction perpendicular to the first direction h, so that the user can conveniently operate the isolating switch from the side. The direction perpendicular to the first direction h is not particularly limited in the present disclosure, for example, the second direction i in FIG. 19 or the third direction j in FIG. 19.

Optionally, as shown in FIG. 19 and FIG. 24, the operating mechanism 010 may be accommodated inside an operating housing 0100.

Optionally, as shown in FIG. 23, the operating mechanism 010 may be a four-bar linkage mechanism, so that the four-bar linkage mechanism can be used to acquire stable two-stage release performance, which ensures the breaking stability of the switch, and can also better match with the layout of the isolating switch of the present disclosure, thereby effectively improving the stability of opening and closing and shortening the research and development cycle on the basis of ensuring the breaking consistency of the isolating switch. The present disclosure does not particularly limit the specific structure of the four-bar linkage mechanism. Of course, in other embodiments, the operating mechanism 010 may also adopt a rotary energy storage mechanism, or a five-bar linkage mechanism, a six-bar linkage mechanism, or other various forms.

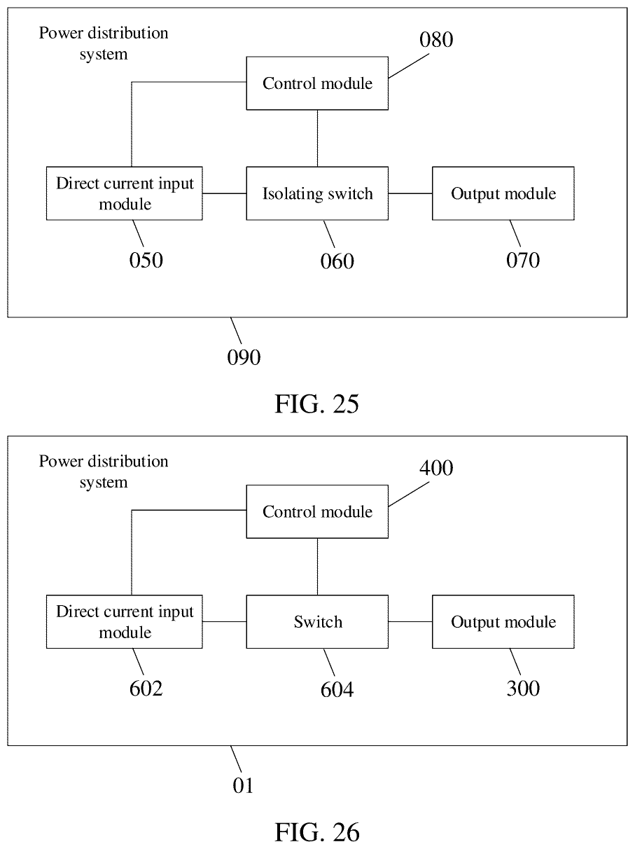

Another aspect of the embodiments of the present disclosure, as shown in FIG. 25, provides a power distribution system 090, including a direct current input module 050, an output module 070, and any one of the above isolating switches 060, where the isolating switch 060 is electrically connected between the direct current input module 050 and the output module 070. Thus, the direct current input module 050 can form a communicating circuit with the output module 070 through the isolating switch 060 in a closed state. Moreover, the isolating switch 060 may also be controlled to be switched from the closed state to an open state, so that the circuit is cut off in time when breaking is needed.

Optionally, as shown in FIG. 25, the power distribution system 090 further includes a control module 080, and the control module 080 may be electrically connected to the isolating switch 060, so that the isolating switch 060 may be controlled by the control module 080, in other words, the isolating switch 060 may be switched from the closed state to the open state under the control of the control module 080, so as to achieve the function of remotely controlling opening, and facilitate timely cutting off a circuit and protecting a device when the circuit of the power distribution system 090 fails.

In actual use, when the direct current input module 050 or the output module 070 fails, the control module 080 responds in time and transmits a fault signal to the isolating switch 060, so that the isolating switch 060 is rapidly switched from the closed state to the open state after receiving the fault signal, and cuts off the circuit.

Optionally, the control module 080 may have a capacitor module, and the power distribution system 090 may charge the capacitor module when the power distribution system 090 is powered on. When the power distribution system 090 fails and needs to break the circuit, the capacitor module of the control module 080 discharges and releases energy to transmit a fault signal to the isolating switch 060, and the isolating switch 060 acts in time after receiving the fault signal, so that the circuit is cut off. After the fault is removed, the isolating switch 060 may be closed again, so that the circuit of the power distribution system 090 is powered on, and at this time, the capacitor module is recharged, so that a fault signal can be transmitted to the isolating switch 060 in time by discharging and releasing energy when a fault occurs next time.

Optionally, in order to ensure that the isolating switch 060 can be opened accurately, the energy released by the capacitor module should be enough to overcome the resistance so as to drive the isolating switch 060 to complete an opening action. The operating mechanism 010 of the isolating switch 060 may further include an energy storage element, that is, when the isolating switch 060 is switched from the open state to the closed state, the energy storage element can store energy, and when the isolating switch 060 releases the closed state in a release manner, the energy storage element can release energy, so that the energy is utilized to drive the isolating switch 060 to be switched from the closed state to the open state, that is, to drive the contacts in the isolating switch 060 to be opened.

One aspect of the embodiments of the present disclosure provides a power distribution system 01 having a switch 604, and the power distribution system 01 to which the switch 604 is applied can have good breaking performance by using the new structure of the switch 604.

As shown in FIG. 26, the power distribution system 01 includes a switch 604, a direct current input module 602, and an output module 300, where the switch 604 is electrically connected between the direct current input module 602 and the output module 300, so that the direct current input module 602 can form a communicating circuit with the output module 300 through the switch 604 in the closed state. Moreover, the switch 604 may also be controlled to be switched from the closed state to the open state, so that the circuit is cut off in time when breaking is needed.

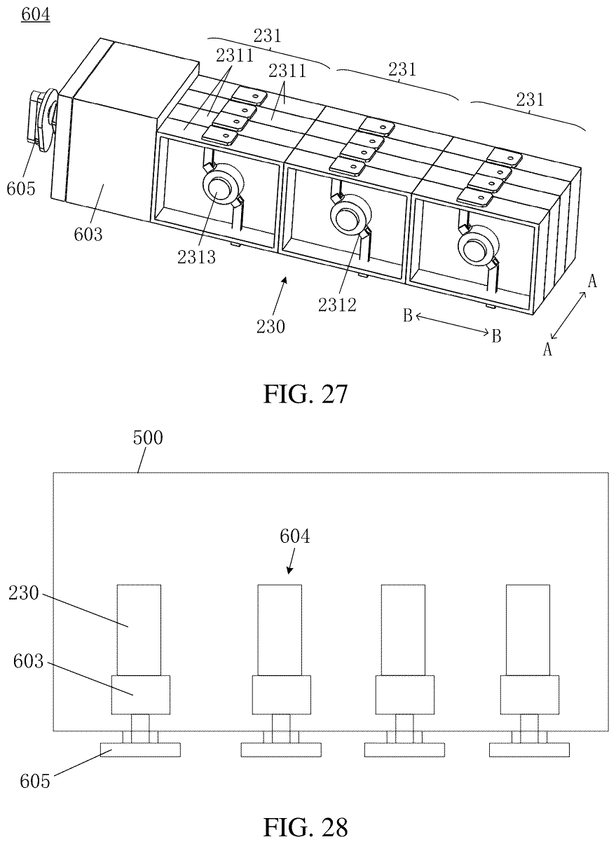

As shown in FIG. 27, the switch 604 includes a breaking body 230 and an action mechanism 603, where the direct current input module 602 may be electrically connected to the output module 300 through a contact assembly 2312 in the breaking body 230, the action mechanism 603 is in driving connection to the breaking body 230, and specifically, the action mechanism 603 may be in driving connection to the contact assembly 2312 in the breaking body 230, so that under the control of the action mechanism 603, the breaking body 230 can be opened or closed, that is, the contact assembly 2312 in the breaking body 230 can be switched from the open state to the closed state, or from the closed state to the open state, thereby meeting the on-off requirement of the power distribution system 01.

With continued reference to FIG. 27, the breaking body 230 rotates around a first direction D, that is, the contact assembly 2312 in the breaking body 230 rotates with the first direction D as an axis to achieve opening and closing, the action mechanism 603 rotates around a second direction E, that is, the action mechanism 603 rotates with the second direction E as an axis to achieve an action; in the case that the first direction D does not overlap with the second direction E, the breaking body 230 and the action mechanism 603 form a non-coaxial structure, so that adverse effects caused by assembly errors are reduced, and the breaking performance of the power distribution system 01 is effectively improved.

It should be understood that, in order to protect the action mechanism 603, a housing is disposed outside the action mechanism 603 for covering, for example, in FIG. 27, the action mechanism 603 is located inside a square housing on one side of the breaking body 230. Of course, the form of the housing is not particularly limited in the present disclosure, and the housing may be in any shape. In addition, the contact assembly 2312 in the present disclosure should include a movable contact and a stationary contact that cooperate with each other. Of course, the present disclosure does not limit the quantity of break points of the contact assembly 2312, for example, the contact assembly may be in various forms such as a single-break point structure or a double-break point structure, which may be reasonably selected according to actual requirements.

When the first direction and the second direction do not overlap, various forms may be provided, so that the action mechanism 603 of the switch 604 and the breaking body 230 can have various arrangement modes, and various switches 604 with different structural forms are formed, so as to meet the installation and use requirements of various scenes. Schematically: for example, the first direction and the second direction may be parallel. For another example, the first direction and the second direction may intersect, that is, the rotation center axis of the breaking body 230 intersects the action mechanism 603, so that an included angle (which may be an acute angle, a right angle, or an obtuse angle) is formed; further, as shown in FIG. 27, when the first direction D is perpendicular to the second direction E, the action mechanism 603 rotates with the second direction E as an axis when acting, and the contact assembly 2312 in the breaking body 230 rotates with the first direction D as an axis when acting, that is, the rotation shaft of the breaking body 230 is perpendicular to the rotation shaft of the action mechanism 603 in the extension direction.

Optionally, as shown in FIG. 27, the switch 604 may further include an operating handle 605, and the operating handle 605 is in driving connection to the action mechanism 603, so that when an operation such as manual closing is required, the user can conveniently operate the switch. The operating handle 605 may rotate with a third direction as an axis, specifically, the third direction may not overlap with the first direction; for example: the third direction is parallel to the first direction, that is, the rotation shaft of the operating handle 605 is parallel to the rotation shaft of the breaking body 230; for another example: the third direction and the first direction intersect, and further may be perpendicular, that is, the rotation shaft of the operating handle 605 is perpendicular to the rotation shaft of the breaking body 230 in the extension direction.

Optionally, the breaking body 230 is constituted of a plurality of body assemblies 231, each body assembly 231 has a rotation central shaft 2313, single bodies 2311 are stacked in the body assembly 231 along a first direction in which the rotation central shaft 2313 extends, each single body 2311 has a contact assembly 2312 therein, and the contact assembly 2312 can rotate around the corresponding rotation central shaft 2313, so as to achieve opening and closing. For example, as shown in FIG. 27, the breaking body 230 includes three body assemblies 231, each body assembly 231 includes four bodies 2311, the four bodies 2311 are coaxial and thus have the same rotation central shaft 2313, and the four bodies 2311 are stacked along the first direction D in which the rotation central shaft 2313 extends. Further, as shown in FIG. 27, the action mechanism 603 and the breaking body 230 are arranged along a second direction E perpendicular to the first direction, so that the plurality of bodies 2311 in the body assembly 231 can be closer to the action mechanism 603, and adverse effects caused by assembly errors during transmission of the plurality of bodies 2311 and the action mechanism 603 can be conveniently relieved.

Optionally, the body assemblies 231 are arranged along a direction perpendicular to the first direction. For example, as shown in FIG. 27, the breaking body 230 includes three body assemblies 231 arranged along the second direction E perpendicular to the first direction D, each body assembly 231 is coaxial, i.e., has the same rotation central shaft 2313, and the rotation central shaft 2313 extends along the first direction D; since the three body assemblies 231 are arranged along the second direction E, the quantity of coaxial bodies 2311 in each body assembly 231 can be reduced when the single bodies 2311 of the same quantity are arranged.

Optionally, as shown in FIG. 27, the breaking body 230, the action mechanism 603, and the operating handle 605 are sequentially stacked along the direction perpendicular to the first direction, and a front-side operation structure may be formed, that is, the operating handle 605, the action mechanism 603, and the breaking body 230 are arranged along the second direction E perpendicular to the first direction D.

Optionally, the stacking direction of the breaking body 230 and the action mechanism 603 may intersect or be perpendicular to the stacking direction of the action mechanism 603 and the operating handle 605, so that a lateral operation structure can be formed.

For example: when the first direction is parallel to the second direction, a lateral operation structure may be formed, that is, the action mechanism 603 and the breaking body 230 are arranged along the direction perpendicular to the first direction, and the operating handle 605 and the action mechanism 603 are arranged along the second direction, or a front-side operation structure may be correspondingly formed, that is, the operating handle 605, the action mechanism 603, and the breaking body 230 are arranged along the direction perpendicular to the first direction.

Optionally, as shown in FIG. 26, the power distribution system 01 further includes a control module 400, and the control module 400 may be electrically connected to the switch 604, so that the switch 604 may be controlled by the control module 400, in other words, the switch 604 may be switched from the closed state to the open state under the control of the control module 400, so as to achieve the function of remotely controlling opening, and facilitate timely cutting off a circuit and protecting a device when the circuit of the power distribution system 01 fails.

In actual use, when the input module or the output module 300 fails, the control module 400 responds in time and transmits a fault signal to the switch 604, so that the switch 604 is rapidly switched from the closed state to the open state after receiving the fault signal, and cuts off the circuit.

Optionally, the control module 400 may have a capacitor module, and the power distribution system 01 may charge the capacitor module when the power distribution system 01 is powered on. When the power distribution system 01 fails and needs to break the circuit, the capacitor module of the control module 400 discharges and releases energy to transmit a fault signal to the switch 604, and the switch 604 acts in time after receiving the fault signal, so that the circuit is cut off. After the fault is removed, the switch 604 may be closed again, so that the circuit of the power distribution system 01 is powered on, and at this time, the capacitor module is recharged, so that a fault signal can be transmitted to the switch 604 in time by discharging and releasing energy when a fault occurs next time.

Optionally, in order to ensure that the switch 604 can be opened accurately, the energy released by the capacitor module should be enough to overcome the resistance so as to drive the switch 604 to complete an opening action. The action mechanism 603 of the switch 604 may further include an energy storage element, that is, when the switch 604 is switched from the open state to the closed state, the energy storage element can store energy, and when the switch 604 releases the closed state in a release manner, the energy storage element can release energy, so that the energy is utilized to drive the switch 604 to be switched from the closed state to the open state, that is, to drive the contacts in the switch 604 to be opened.

Optionally, when the contact assembly 2312 is of a double-break point structure, the contact assembly has two stationary contacts capable of being opened and closed with the same movable contact, and when the output module 300 is electrically connected to the switch 604, the output module 300 may be partially fixedly connected to the switch 604, so that the connection between the output module and the switch is relatively stable. For example, the output module 300 may be directly soldered to one stationary contact of the switch 604.

Optionally, when the contact assembly 2312 is of a double-break point structure, the contact assembly has two stationary contacts capable of being opened and closed with the same movable contact; when the direct current input module 602 is electrically connected to the switch 604, the direct current input module 602 may be connected to the switch 604, and the direct current input module 602 is connected to the other stationary contact of the switch 604 through a wire, so that connection flexibility can be improved, and it is easy to adapt to various wiring environments. When the connection of the wire and the stationary contact is achieved, the wiring can be carried out in a screw fastening manner, and therefore the stability of the wiring can be guaranteed.

Optionally, as shown in FIG. 28, the power distribution system 01 further includes a box body 500, and a partial structure of the power distribution system 01 may be protected by the box body 500. For example, as shown in FIG. 28, the operating handle 605 of the switch 604 is disposed on an outer side of the box body 500, so that the user can conveniently manually operate the switch. The breaking body 230, the action mechanism 603, and the output module 300 of the switch 604 are disposed inside the box body 500, so that the tank 500 can well protect these components from external interference.

Optionally, since the operating handle 605 needs to penetrate through the box body 500, a rubber sealing gasket may be disposed between the box body 500 and the operating handle 605, so as to improve the isolation degree between the inside and the outside of the box body 500, and further improve the protection capability of the box body 500.

Optionally, as shown in FIG. 28, a plurality of switches 604 may be arranged side by side on the same side of the box body 500. Of course, in other embodiments, the plurality of switches 604 may be distributed on different sides of the box body 500, and the specific arrangement may be selected according to actual environments.

The above are only preferred embodiments of the present disclosure, and are not intended to limit the present disclosure. For those skilled in the art, the present disclosure can be modified and varied. Any modification, equivalent replacement, improvement, and the like made within the spirit and principle of the present disclosure shall all fall within the protection scope of the present disclosure.

### INDUSTRIAL APPLICABILITY

According to the isolating switch body, the isolating switch, and the power distribution system of the present disclosure, the isolating switch body includes body modules, where each body module includes a plurality of layers of switch units which are stacked, the plurality of layers of switch units are connected through respective body rotating shafts, and a plurality of groups of body modules are spliced to form the isolating switch body; the body rotating shafts of the switch units are linked with an operating mechanism through a transmission mechanism in a first direction perpendicular to a stacking direction. The handle shaft is rotated to drive the operating mechanism to act, and then the body modules are driven through the transmission mechanism to achieve synchronous opening and closing. When the isolating switch body is applied to the isolating switch, the above body modules can be disposed in the first direction and the stacking direction separately, the two-way layout method can effectively reduce the length of the isolating switch in the first direction, and then the synchronization among the plurality of layers of switch units is ensured. The isolating switch body, the isolating switch, and the power distribution system of the present disclosure can be applied to the fields of buildings, electric power, and industry.

1. An isolating switch, characterized by comprising an operating mechanism and a switch body, wherein the operating mechanism is in driving connection to the switch body to drive the switch body to be opened or closed, and extension directions of a rotation shaft of the operating mechanism and a rotation shaft of the switch body do not overlap.

2. The isolating switch according to claim 1, characterized in that the extension directions of the rotation shaft of the operating mechanism and the rotation shaft of the switch body are parallel or perpendicular.

3. The isolating switch according to claim 2, characterized in that the switch body comprises at least one switch assembly, the switch assembly has a rotation shaft extending along a first direction and in driving connection to the operating mechanism, and the switch assembly comprises at least one switch unit stacked along the first direction.

4. The isolating switch according to claim 3, characterized in that the switch assemblies are stacked along a second direction perpendicular to the first direction.

5. The isolating switch according to claim 3, characterized in that the operating mechanism and the switch body are stacked along the second direction perpendicular to the first direction.

6. The isolating switch according to claim 5, characterized by further comprising a transmission member extending along the second direction, wherein the operating mechanism is in driving connection to the rotation shaft of the switch assembly through the transmission member.

7. The isolating switch according to claim 6, characterized in that a plurality of switch units of the same switch assembly are all distributed on the same side of the transmission member,
or, a plurality of switch units of the same switch assembly are distributed on opposite sides of the transmission member.

8. The isolating switch according to claim 7, characterized in that the plurality of switch units of the same switch assembly are symmetrically distributed on opposite sides of the transmission member.

9. The isolating switch according to claim 6, characterized in that the transmission member comprises a translational portion and a rotary portion which are connected to each other, the translational portion extends along the second direction, and the operating mechanism is in driving connection to the rotation shaft of the switch assembly sequentially through the translational portion and the rotary portion, wherein
the translational portion is a connecting bar, and the rotary portion is hinged to the connecting bar, or, the translational portion is a rack, and the rotary portion is a gear meshing with the rack.

10. The isolating switch according to claim 5, characterized in that the isolating switch further comprises a handle, the handle is in driving connection to the switch body through the operating mechanism, and the handle, the operating mechanism, and the switch body are arranged along the second direction;
or, the isolating switch further comprises a handle, the handle is in driving connection to the switch body through the operating mechanism, and the handle and the operating mechanism are arranged along a direction perpendicular to the second direction.

11. The isolating switch according to claim 1, characterized in that a release is disposed on one side of the operating mechanism, the release has a driving portion, the operating mechanism has a driven portion in driving cooperation with the driving portion, and a gap is formed between the driving portion and the driven portion.

12. An isolating switch, characterized by comprising an operating mechanism and a switch body, wherein the switch body comprises at least one layer of switch assembly stacked along a first direction, the switch assembly comprises a plurality of switch units arranged on the same layer, at least two switch units located on the same layer are connected in series inside the switch assembly, and the operating mechanism is in driving connection to the switch units in the switch body to drive the switch body to be opened or closed.

13. The isolating switch according to claim 12, characterized in that at least two switch units located on the same layer are connected in series inside the switch assembly to form a series connection group, the plurality of switch units located on the same layer form a plurality of series connection groups, and the plurality of series connection groups are connected in parallel and/or in series.

14. The isolating switch according to claim 12, characterized in that at least two adjacent switch units in the plurality of switch units located on the same layer are connected in series.

15. The isolating switch according to claim 12, characterized in that each switch unit has a rotation shaft in driving connection to the operating mechanism, and the rotation shafts of the plurality of switch units located on the same layer are parallel to each other.

16. The isolating switch according to claim 15, characterized in that the switch body comprises a plurality of layers of switch assemblies, the switch units in two adjacent layers of switch assemblies are stacked in one-to-one correspondence along the first direction, and the rotation shafts of the switch units stacked correspondingly along the first direction in the plurality of layers of switch assemblies are coaxially disposed.

17. The isolating switch according to claim 15, characterized in that an axis of a rotation shaft of the operating mechanism does not overlap with an axis of the rotation shaft of each switch unit, and the axis of the rotation shaft of the operating mechanism is parallel or perpendicular to the axis of the rotation shaft of each switch unit.

18. The isolating switch according to claim 12, characterized in that the operating mechanism and the switch body are stacked along the first direction or along a second direction perpendicular to the first direction.

19. The isolating switch according to claim 12, characterized in that a plug-in terminal for being plugged with a circuit board is provided on one side of the switch body.

20. A power distribution system, characterized by comprising a switch, a direct current input module, and an output module, wherein the switch is electrically connected between the direct current input module and the output module, the switch can be controlled to be switched from a closed state to an open state, the switch comprises a breaking body and an action mechanism, the breaking body rotates around a first direction, the action mechanism rotates around a second direction, and the first direction does not overlap with the second direction.
